(19) United States
(12) Patent Application Publication
(10) Pub. No.: US 2008/0147642 A1
(43) Pub. Date: Jun. 19, 2008

(54) SYSTEM FOR DISCOVERING DATA ARTIFACTS IN AN ON-LINE DATA OBJECT

(76) Inventors: Dean Leffingwell, Louisville, CO (US); Jeremie Miller, Cascade, IA (US); Donald R. Widrig, Estes Park, CO (US); Aleksey Korolev, Kyiv (UA); Oleksandr Yakyma, Kyiv (UA)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/683,941

(22) Filed: Mar. 8, 2007

Related U.S. Application Data
(63) Continuation-in-part of application No. 11/610,936, filed on Dec. 14, 2006.

(51) Int. Cl. G06F 17/30

(52) U.S. Cl. 707/5

(57) ABSTRACT

A system for discovering data artifacts in an on-line data object is described. One embodiment includes a data acquisition subsystem configured to parse the on-line data object into at least one string; a string pre-parser configured to divide each string into a set of separate characters; a lexical analyzer configured, for each set of separate characters, to aggregate the separate characters in that set of separate characters into a sequence of tokens, each token in the sequence of tokens being one of a word, a punctuation symbol, a HyperText-Markup-Language tag, and a number; a syntax analyzer configured, for each sequence of tokens during a first analysis phase, to determine, for each of a plurality of rule sets, whether the sequence of tokens includes one or more candidate data artifacts of a distinct type to which that rule set corresponds, each of the plurality of rule sets being adapted to discovery of the distinct type of data artifact to which that rule set corresponds, at least one rule set in the plurality of rule sets including a context-free grammar; compute, for each candidate data artifact of a distinct type, a probability ranking indicating a degree of likelihood that the candidate data artifact is a data artifact of that distinct type; and classify each candidate data artifact as a data artifact of the distinct type for which a most favorable probability ranking was computed for that candidate data artifact, the syntax analyzer being configured to associate with each classified data artifact a subject found within the on-line data object; and a storage subsystem including at least one data structure in which to store the classified data artifacts, the storage subsystem being configured to index and organize the classified data artifacts by subject for retrieval in response to a search query indicating a particular subject.

### PRIORITY

The present application is a continuation in part of commonly owned and assigned U.S. application Ser. No. 11/610,936, Attorney Docket No. SKOO-001/00US, entitled “Method and System for Collecting and Retrieving Information from Web Sites,” filed on Dec. 14, 2006, which is incorporated herein by reference.

### RELATED APPLICATIONS

The present application is related to the following commonly owned and assigned applications: U.S. Application No. (unassigned), Attorney Docket No. SKOO-001/01US, “Method for Prioritizing Search Results Retrieved in Response to a Computerized Search Query,” filed herewith; U.S. Application No. (unassigned), Attorney Docket No. SKOO-001/02US, “Method for Discovering Data Artifacts in an On-Line Data Object,” filed herewith; and U.S. Application No. (unassigned), Attorney Docket No. SKOO-001/03US, “System for Prioritizing Search Results Retrieved in Response to a Computerized Search Query,” filed herewith.

### FIELD OF THE INVENTION

The present invention relates generally to information storage and retrieval systems. In particular, but not by way of limitation, the present invention relates to systems for discovering data artifacts in an on-line data object such as a Web page, Usenet posting, e-mail message, or Web feed.

### BACKGROUND OF THE INVENTION

The Internet, in particular the portion known as the World Wide Web (the “Web”), has become a repository for an astronomical amount of information about a wide variety of subjects. As experienced Web users are aware, finding specific information of interest among the vast stores of available information can be challenging.

To address this need to find information on the Web, a number of Web search sites have been developed. Search sites such as GOOGLE employ various algorithms to rank Web pages according to their relevance to one or more search terms. Other search sites such as ZOOMINFO have emerged that focus on finding information about people and the organizations (e.g., companies) with which they are associated. To find specific information using a conventional search engine, the user either has to know enough details about the subject beforehand to focus the search or has to be willing to sort through a large number of Web pages one by one to locate the relevant information.

Some Web searches do not lend themselves well to a conventional search engine such as GOOGLE or ZOOMINFO. For example, a user might desire information about a person named Bob Smith whom the user met at a social function several weeks before. The user does not remember that the Bob Smith of interest lives in Nevada but does remember that he likes to fish. The user also knows that Bob Smith works closely with a colleague whose name the user cannot quite remember, but the user thinks he or she would recognize the colleague's name if he or she were to see it again. Using a conventional search engine to find information about this specific Bob Smith under these circumstances would be extremely difficult, especially since “Bob Smith” is a very common name and the user does not even know the state in which this particular Bob Smith lives. Moreover, the user cannot search for Web pages mentioning both Bob Smith and Smith's colleague because the user cannot remember the colleague's name.

Similar challenges can arise where the user seeks information from the Web about subjects other than people. For example, a user might desire information associated with a specific location, organization, hobby or interest, or other subject. Finding such information using a conventional search engine can be daunting, especially where the user's knowledge of the subject is sketchy or incomplete.

It is thus apparent that there is a need in the art for an improved method and system for collecting and retrieving information from Web sites.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system for discovering data artifacts in an on-line data object. One illustrative embodiment comprises a data acquisition subsystem configured to parse the on-line data object into at least one string; a string pre-parser configured to divide each string into a set of separate characters; a lexical analyzer configured, for each set of separate characters, to aggregate the separate characters in that set of separate characters into a sequence of tokens, each token in the sequence of tokens being one of a word, a punctuation symbol, a HyperText-Markup-Language tag, and a number; a syntax analyzer configured, for each sequence of tokens during a first analysis phase, to determine, for each of a plurality of rule sets, whether the sequence of tokens includes one or more candidate data artifacts of a distinct type to which that rule set corresponds, each of the plurality of rule sets being adapted to discovery of the distinct type of data artifact to which that rule set corresponds, at least one rule set in the plurality of rule sets including a context-free grammar; compute, for each candidate data artifact of a distinct type, a probability ranking indicating a degree of likelihood that the candidate data artifact is a data artifact of that distinct type; and classify each candidate data artifact as a data artifact of the distinct type for which a most favorable probability ranking was computed for that candidate data artifact, the syntax analyzer being configured to associate with each classified data artifact a subject found within the on-line data object; and a storage subsystem including at least one data structure in which to store the classified data artifacts, the storage subsystem being configured to index and organize the classified data artifacts by subject for retrieval in response to a search query indicating a particular subject.

This and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a system for collecting and retrieving information from Web sites in accordance with an illustrative embodiment of the invention;

FIGS. 2A and 2B are mock screenshots showing search results before and after triangulation, respectively, in accordance with an illustrative embodiment of the invention;

FIG. 2C is a mock screenshot showing additional kinds of search results in accordance with an illustrative embodiment of the invention;

FIG. 3 is a diagram illustrating an example of the focusing of search results (triangulation) in accordance with an illustrative embodiment of the invention;

FIG. 4 is a functional block diagram of time-based searching in accordance with an illustrative embodiment of the invention;

FIG. 5A is a process flow diagram of a process for classifying data artifacts discovered on Web pages in accordance with an illustrative embodiment of the invention;

FIG. 5B is a diagram showing the association of data artifacts with a single subject entry in the data structures when the subject is non-unique, in accordance with an illustrative embodiment of the invention;

FIG. 6 is a diagram of data importation and exportation in accordance with an illustrative embodiment of the invention;

FIG. 7 is a diagram of Web-based application programming interfaces (APIS) in accordance with an illustrative embodiment of the invention;

FIG. 8 is a diagram of a distributed search architecture in accordance with an illustrative embodiment of the invention;

FIG. 9 is a flowchart of a method for collecting information from Web sites in accordance with an illustrative embodiment of the invention;

FIG. 10 is a flowchart of a method for collecting and retrieving information from Web sites in accordance with another illustrative embodiment of the invention;

FIG. 11 is a flowchart of a method for collecting and retrieving information from Web sites in accordance with another illustrative embodiment of the invention;

FIG. 12 is a flowchart of a method for collecting and retrieving information from Web sites in accordance with yet another illustrative embodiment of the invention;

FIG. 13 is a flowchart of a method for associating a data artifact with a search subject in accordance with an illustrative embodiment of the invention;

FIG. 14 is a flowchart of a method for exporting search results in accordance with an illustrative embodiment of the invention;

FIG. 15 is a flowchart of a method for importing search queries in accordance with an illustrative embodiment of the invention;

FIG. 16 is a flowchart of a method for processing a request for information collected from Web sites in accordance with an illustrative embodiment of the invention;

FIG. 17 is a flowchart of a method for obtaining information collected from Web sites in accordance with an illustrative embodiment of the invention;

FIG. 18 is a functional block diagram of an inference, classification, and indexing (ICI) subsystem in accordance with an illustrative embodiment of the invention;

FIG. 19 is a flowchart of a method for discovering data artifacts in an on-line data object in accordance with an illustrative embodiment of the invention;

FIG. 20 is a flowchart of a method for applying, to a sequence of tokens, each of a plurality of rule sets, each rule set corresponding to a distinct type of data artifact, in accordance with an illustrative embodiment of the invention;

FIG. 21 is a flowchart of a method for prioritizing search results retrieved in response to a computerized search query in accordance with an illustrative embodiment of the invention;

FIG. 22 is a flowchart of a method for assigning a global ranking to a data artifact in a set of data artifacts retrieved as search results from an indexed and organized collection of data artifacts in accordance with an illustrative embodiment of the invention;

FIG. 23 is an illustration showing the use of different font sizes to indicate the relative global rankings of displayed data artifacts in accordance with an illustrative embodiment of the invention;

FIG. 24 is a flowchart of a method for assigning a global ranking to an associate data artifact in accordance with an illustrative embodiment of the invention;

FIG. 25 is a flowchart of a method for applying a text-block rule set to a sequence of tokens in accordance with an illustrative embodiment of the invention;

FIG. 26 is a flowchart of a method for assigning a local ranking to an occurrence of a text-block data artifact in accordance with an illustrative embodiment of the invention;

FIG. 27 is a flowchart of a method for applying a tags rule set to a sequence of tokens in accordance with an illustrative embodiment of the invention;

FIG. 28 is a flowchart of a method for assigning a global ranking to a URL data artifact in accordance with an illustrative embodiment of the invention;

FIG. 29A is a functional block diagram of a storage subsystem in accordance with an illustrative embodiment of the invention;

FIG. 29B is a diagram of a fast index associated with a storage subsystem in accordance with an illustrative embodiment of the invention; and

FIG. 29C is a diagram of an artifact dictionary associated with a storage subsystem in accordance with an illustrative embodiment of the invention.

### DETAILED DESCRIPTION

Searches of the World Wide Web (the “Web”) for information about a subject can be greatly enhanced by presenting to the user categorized, organized information items associated with the subject that have been gleaned from a comprehensive collection of Web pages.

In an illustrative embodiment of the invention, a set of Web pages is acquired. This set of Web pages may constitute the entire Web or a significant portion thereof at a particular point in time. For each page in the set of Web pages, the Web page is analyzed for the presence of one or more data artifacts. As used herein, a “data artifact” is an item of information found on a Web page. Each identified data artifact is classified as one of a predetermined set of types. Examples of types include, without limitation, a name of a person, a geographic location, an organization, a clipping, an item concerning someone's education, an identifier associated with a manner of electronically contacting a person, a hobby, an interest, a biography, or an item of miscellaneous information. In other embodiments, a variety of other data-artifact types can be defined as needed to fit a particular application.

Once a data artifact has been classified, it is indexed and organized in one or more data structures. Each indexed and organized data artifact is associated with a subject based on an analysis of relationships or likely relationships between that data artifact and the subject. Where a subject is non-unique, all indexed and organized data artifacts associated with the non-unique subject are associated with a single subject entry in the data structures. In some embodiments, the subject is a name of a person to enable the retrieval of information associated with a specified name. In general, however, a “subject” can be any kind of data item on which a search of the one or more data structures is based and with which a user might desire to find associated information. For example, any of the data-artifact types listed above can be treated as subjects in indexing and organizing the one or more data structures.

When a search query is received indicating a particular subject to be searched, a set of data artifacts associated with the particular subject is retrieved from the data structures. In some embodiments, all data artifacts associated with the specified subject are retrieved. To aid the user in viewing the search results, the data artifacts may be grouped on a display in accordance with their respective types and ranked, within each type, in order of their relevance to the subject. For example, the data artifacts estimated to be most relevant within a given data-artifact type can be listed first, the remaining data artifacts of that type being listed in descending order of relevance.

Once search results associated with the particular subject have been retrieved from the data structures and displayed, the search results can be narrowed in accordance with user input.

In one illustrative embodiment, the subject is a person's name. For example, a user might wish to search for someone named “Bob Smith.” This embodiment returns all data artifacts (e.g., locations, organizations, names of other people, etc.) associated with the name “Bob Smith,” the data artifacts of each type being grouped and displayed in a separate ranked list. In some embodiments, morphological variations of the subject name (e.g., “Robert Smith” or “Rob Smith”) are taken into account. Since there are many Bob Smiths in the world, the number of data artifacts returned is very large. However, by simply selecting a particular data artifact, the user can narrow the search results to, for example, (1) data artifacts found on Web pages containing the selected data artifact or (2) data artifacts found on Web pages that do not contain the selected data artifact. This allows the user to “triangulate” to a specific Bob Smith who resides in Mississippi and who works for a particular company, for example. If desired, the user can “click through” to a Web page on which a particular data artifact was found.

In other embodiments, the principles of the invention may be applied to a variety of other Web-search applications other than searching for information associated with a person's name. Though the examples in this Detailed Description often focus on applications in which the subject to be searched is a person's name, this is not intended in any way to limit the scope of the appended claims.

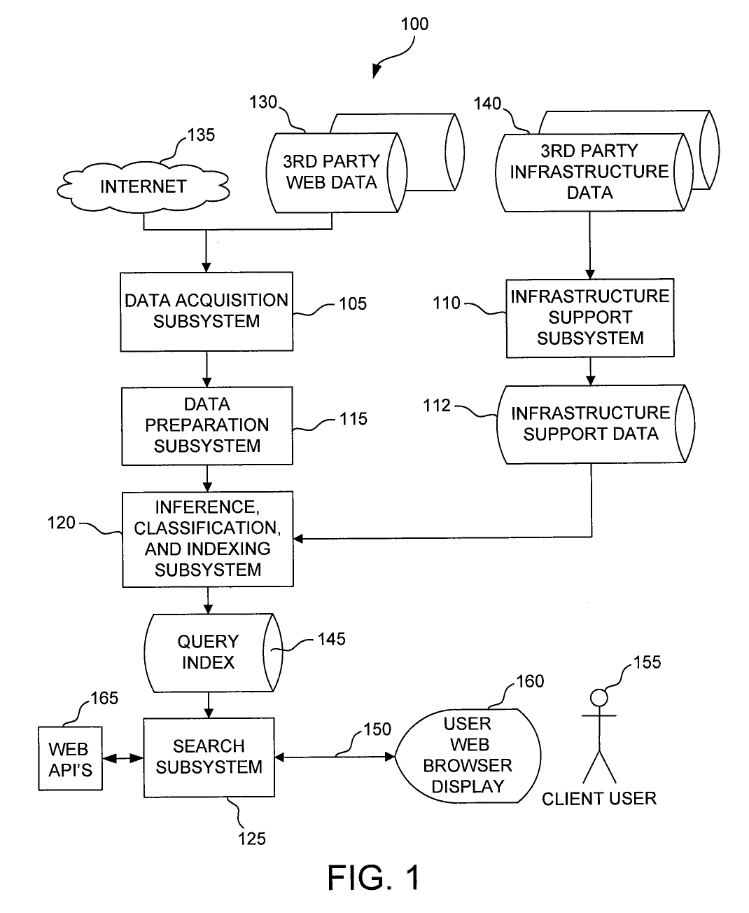

Referring now to the drawings, where like or similar elements are designated with identical reference numerals throughout the several views, and referring in particular to FIG. 1, it is a functional block diagram of a system 100 for collecting and retrieving information from Web sites in accordance with an illustrative embodiment of the invention. System 100 employs a number of techniques to deal with several distinct problems: collection and examination of large amounts of data collected from the entire Web (in a language-specific architecture); heuristic selection of data artifacts of interest (e.g., names, locations, organizations, etc.) from Web pages; preparation of large data structures to contain the data artifacts; preparation of large, search-optimized data structures containing the data artifacts, and rapid and efficient delivery of selected data artifacts to a requesting computer via a graphical user interface (GUI) or client-accessible Web application programming interfaces (APIs).

To address these distinct problems, the embodiment shown in FIG. 1 is organized into five major subsystems: data acquisition subsystem 105; infrastructure support subsystem 110; data preparation subsystem 115; inference, classification, and indexing (“ICI”) subsystem 120; and search subsystem 125. In other embodiments, one or more of these five major subsystems may be omitted, depending on the application. In various embodiments, the functional duties performed by these subsystems may be subdivided or combined in ways other than that shown in FIG. 1, and the subsystems may be called by different names. Such variations are considered to be within the scope of the claims. In general, the functionality of these subsystems may be implemented in software, firmware, hardware, or any combination thereof.

Data acquisition subsystem 105 collects the Web data used by system 100. In one embodiment, data acquisition subsystem 105 acquires third-party Web data 130 from one or more third-party data sources. In other embodiments, data acquisition subsystem 105 acquires Web data by “crawling” the Web via a connection with the Internet 135. In still other embodiments, data acquisition subsystem 105 acquires third-party Web data 130 from one or more third-party data sources and supplements the third-party Web data 130 by crawling the Web. Regardless of the data source, the collected Web pages are normalized and output in a standard format used by other subsystems of system 100. In some embodiments, data acquisition subsystem 105 employs data compression techniques to minimize the data volume collected.

Web pages may be represented in a wide variety of formats such as HyperText Markup Language (HTML), plain text, Portable Document Format (PDF), spreadsheets, word processing documents, etc. System 100 includes a variety of input processors (not shown in FIG. 1) that allow the system to process various data formats in a consistent manner.

Infrastructure support subsystem 110 examines other public and third-party infrastructure data collections 140 to construct lists (infrastructure support data 112) that are used by ICI subsystem 120. For example, infrastructure support subsystem 110 may collect public data for names and addresses in order to build lists of acceptable names of people, cities, states, or other defined types of data. The lists produced by infrastructure support subsystem 110 are used by ICI subsystem 120 to improve the accuracy of data-artifact classification. In some embodiments, infrastructure support subsystem 110 examines public databases on an occasional, intermittent basis to keep abreast of newer names, locations, or other types of data that may not currently reside in the lists it produces.

Data preparation subsystem 115 uses the collected Web data from data acquisition subsystem 105 to feed ICI subsystem 120. Data acquisition subsystem 105 attempts to collect Web data rapidly and efficiently. This can result in data structures that are not necessarily in the best format for subsequent processing by ICI subsystem 120. Data preparation subsystem 115 collects the data from data acquisition subsystem 105 and prepares data structures that are more efficient for subsequent processing.

In some embodiments, data preparation subsystem 115 removes a subset of the Web pages from the Web data collected by data acquisition subsystem 105 before the Web data is passed to ICI subsystem 120. In general, the subset of Web pages removed can be any data that is not intended to be processed by system 100. For example, the Web includes a large percentage of duplicate Web pages. In some embodiments, these duplicate Web pages are removed. As further examples, data preparation subsystem 115, in some embodiments, removes Web pages associated with pornography Web sites, Web pages containing spam, or both. Removing Web data such as duplicate pages, porn, and spam before subsequent processing improves the overall processing efficiency of system 100 by eliminating redundant or unnecessary work.

ICI subsystem 120, using the output of data preparation subsystem 115 and the lists prepared by infrastructure support subsystem 110, applies an extensive set of heuristics and rule-based grammar systems to identify, classify, rank, and store the data artifacts that are used by search subsystem 125. In one illustrative embodiment, ICI subsystem 120 analyzes the Web pages in the data received from data preparation subsystem 115 on a page-by-page basis to find and classify data artifacts. The classification of each data artifact as one of a predetermined set of types is discussed in greater detail in a later portion of this Detailed Description. ICI subsystem 120 indexes and organizes the classified data artifacts in one or more data structures. In the embodiment of FIG. 1, these data structures correspond to query index 145. In indexing and organizing the classified data artifacts, ICI subsystem 120 associates each classified data artifact with a subject to enable efficient retrieval of data artifacts associated with a particular search subject.

In some embodiments, ICI subsystem 120 also assigns a local rank to the classified data artifacts on a page-by-page basis. That is, various ranking rules, specific to each type of data artifact, are applied to the discovered data artifacts on each Web page to estimate the relative rank or importance of those data artifact on the Web page. By way of illustration, the local ranking rules may take into consideration the position of the data artifact on the page (e.g., nearer to the top ranks higher than closer to the bottom), font size (e.g., larger font sizes rank higher than smaller font sizes), font style (e.g., bold-face text ranks higher than normal text), completeness of the artifact (e.g., more fully formed names, for example, rank higher than partial names), the likelihood that the data artifact is of a given type, or other indicators of relative importance.

Search subsystem 125 is the user-visible face of system 100. Search subsystem 125 handles user interface 150 and translates one or more user search queries into lookup processes.

When search subsystem 125 receives a query indicating a particular subject to be searched (a “search subject”), search subsystem 125 retrieves search results from the data structures (e.g., query index 145). The search results retrieved include some or all of the data artifacts associated with the search subject. In many cases, the collected information represents the amalgamated Web footprints of several subjects (e.g., people with the same name or a place name that exists in multiple physical locations) that share a common set of data artifacts. System 100 provides client user 155 with ways to narrow the search results to a particular instance of a subject (e.g., to a specific person called by the name searched or to a specific instance of a place name in a particular location). This aspect of system 100, referred to herein as “triangulation,” is discussed in greater detail in a later portion of this Detailed Description.

Upon collecting the relevant data artifacts for a search request, search subsystem 125 formats and displays the results by collaborating with the user's client-side browser (user Web-browser display 160) to display a nicely formatted set of data artifacts. In some embodiments, search subsystem 125 groups the data artifacts of each type together in the same portion of user Web-browser display 160. For example, each group of data artifacts of the same type may be displayed in its own panel or pane on the display. Within the displayed group of data artifacts of a given type, search subsystem 125 may also arrange the data artifacts in descending order of relevance to the search subject. In one embodiment, search subsystem 125 accomplishes this by assigning a global rank—a measure of relevance to the search subject—to each retrieved data artifact during processing of a query. In this illustrative embodiment, search subsystem 125 assigns the global rank to each retrieved data artifact based on an analysis of that data artifact's local rank and relationships among the retrieved data artifacts. As in the case of local ranking by ICI subsystem 120, various ranking algorithms are applied to the retrieved data artifacts to determine the final importance of each data artifact.

In this illustrative embodiment, global ranking begins by adding together all of the local ranks of the various instances of a given data artifact that is determined to be part of the search results. For example, if the name “John Doe” appears 13 times in the search results, system 100 begins the global ranking process by adding together all of the local ranks that were assigned to the respective occurrences of that name in the search results. System 100 augments the global ranking by taking into consideration specific features that may be particular to a data artifact. For example, the global ranking of an “associate” data artifact—a data artifact, other than the search subject, classified as a name of a person that is inferred to be associated with the search subject—is augmented by its physical proximity to the search subject on one or more Web pages. That is, a data artifact classified as a name of a person that appears closer to an occurrence of the search subject on the underlying Web pages is globally ranked higher than such a data artifact that is found farther away from an occurrence of the search subject. Other global ranking augmentations may be applied depending on the data-artifact type and the relationship of the data artifact to other data artifacts.

In some embodiments, system 100 also includes a set of Web application programming interfaces (APIs) 165 to enable third parties to access some or all of the features of system 100. These APIs are discussed in greater detail in a later portion of this Detailed Description.

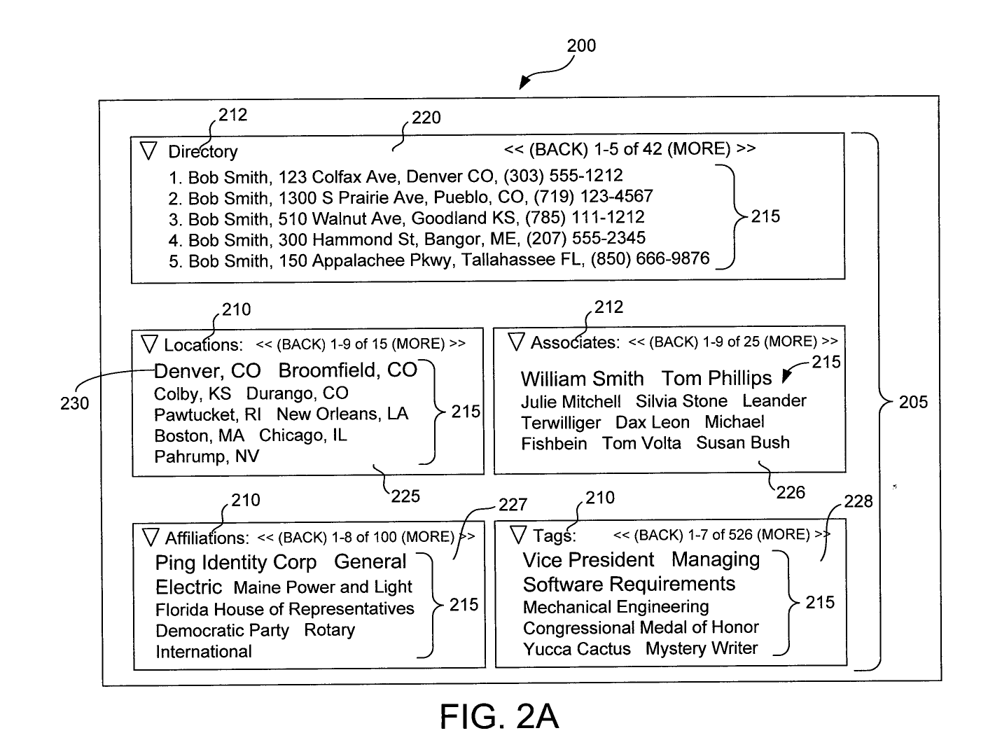

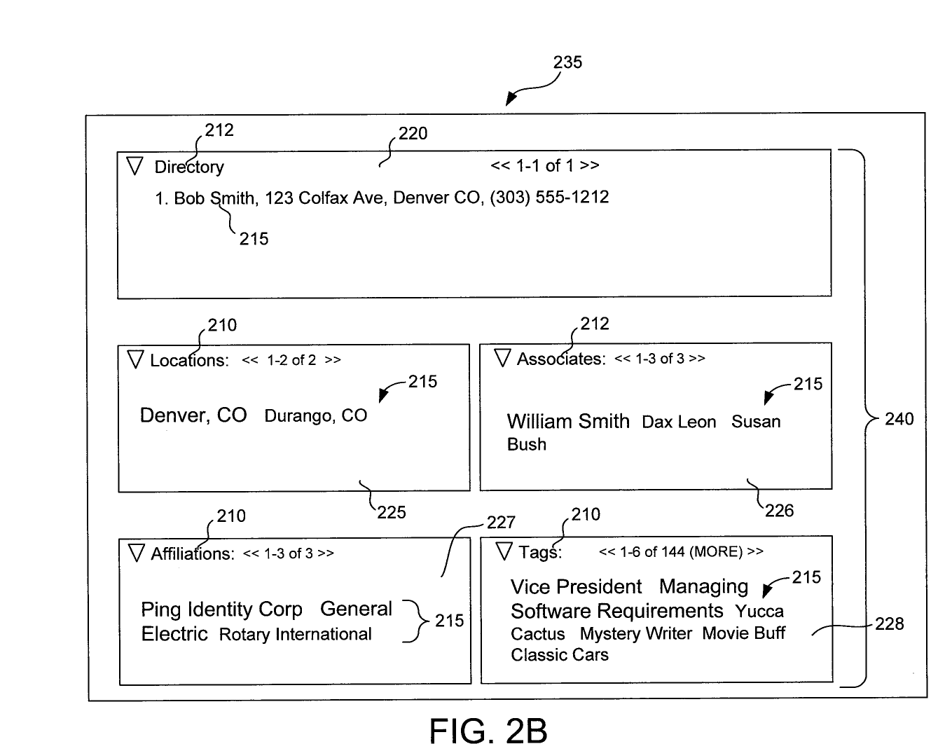

FIGS. 2A and 2B are mock screenshots showing search results before and after triangulation, respectively, in accordance with an illustrative embodiment of the invention. In FIG. 2A, mock screenshot 200 includes search results 205 grouped in accordance with the respective types 210 (or search-result categories 212, where the artifacts 215 are not assigned a type 210 by ICI subsystem 120) of the data artifacts 215. The various types 210 of data artifacts and search-result categories 212 are discussed in greater detail in a later portion of this Detailed Description. For clarity, most data artifacts 215 in FIGS. 2A and 2B have been labeled in groups rather than individually.

In FIG. 2A, the directory section 220 lists the first five of 42 occurrences of a search subject “Bob Smith,” and the location section 225 lists the first nine of 15 different locations associated with those occurrences of the search subject. In response to client user 155 selecting (e.g., clicking on) the specific location “Denver, Colo.” (230) in location section 225, search subsystem 125 limits search results 205 to those data artifacts 215 among the original set of search results 205 that are from Web pages mentioning the location Colorado. FIG. 2B shows a mock screenshot 235 containing the resulting triangulated search results 240.

FIG. 2C is a mock screenshot showing additional kinds of search results in accordance with an illustrative embodiment of the invention. For simplicity, only a few representative kinds of data artifacts 215 are shown in FIGS. 2A and 2B. Mock screenshot 245 in FIG. 2C includes two additional kinds of data artifacts 215: clippings and Uniform Resource Locators (URLs). In general, the number of different kinds of data artifacts 215 that search subsystem 125 displays depends on the particular embodiment.

As indicated in FIG. 2C, “clipping” is a data-artifact type 210 assigned by ICI subsystem 120 to clipping data artifacts 215. In this example, clippings section 250 contains a list of clippings associated with the search subject “Bob Smith.”

URLs section 255 contains a relevance-ranked list of URLs. Though they are data artifacts 215, URLs are not, in this illustrative embodiment, assigned a data-artifact type 210 during classification by ICI subsystem 120. The relevance-ranked list of URLs in URLs section 255 is a list of all of the various URLs that participated in the search for the subject “Bob Smith.” That is, the list includes the URLs of the Web pages from which the data artifacts 215 constituting the search results were obtained. It is advantageous to present the list of URLs in descending order of their relevance to the search subject. For example, the URLs can be prioritized in accordance with their information density in relation to the search subject.

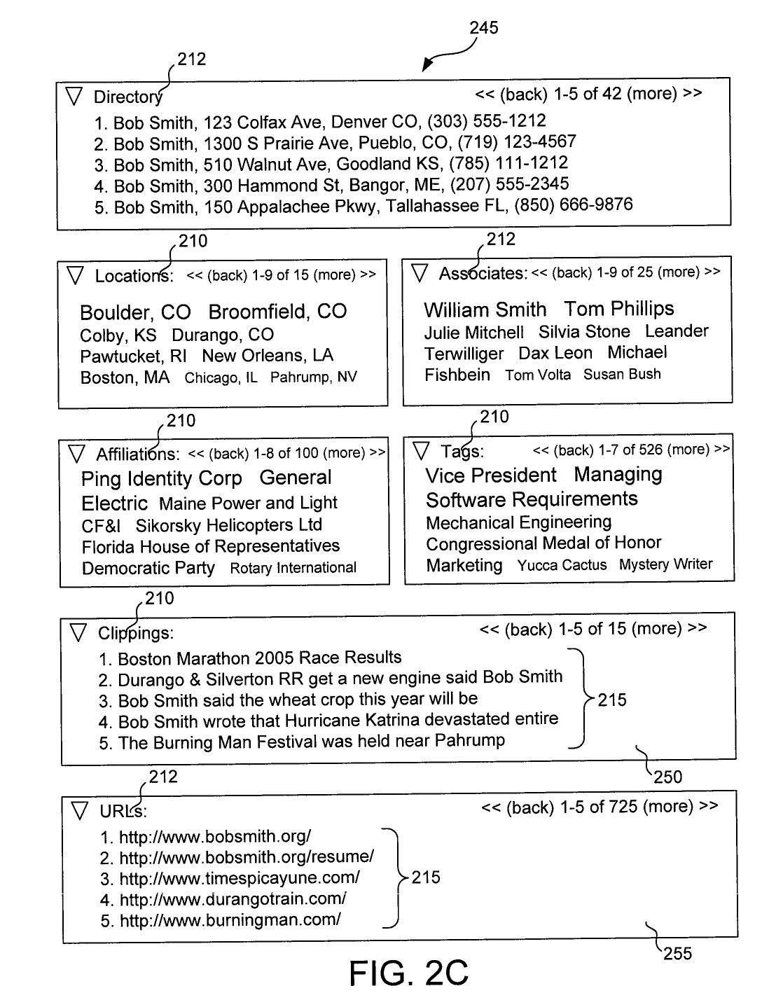

FIG. 3 is a diagram illustrating an additional example of triangulation in accordance with an illustrative embodiment of the invention. In this example, a client user 155 has submitted a query for the search subject “Bob Smith.” The top set of boxes in FIG. 3 represents some of the data artifacts 215 retrieved prior to triangulation. These initial data artifacts indicate that the name “Bob Smith” is likely to be associated with John Doe, David Rockefeller, and Willie Nelson; that the name “Bob Smith” is likely to be affiliated with the Republican Party, General Electric Co., and Chase Manhattan Bank; and that Nelson Rockefeller has written something (a “clipping”) about someone named Bob Smith.

In the example of FIG. 3, client user 155 subsequently selects a particular data artifact 305 (“Republican”). By selecting this particular data artifact 305, client user 155 is telling system 100 to filter the search results to include only data artifacts 215 among the original search results that originated from Web pages containing the particular data artifact 305. The bottom boxes in FIG. 3 represent some of the data artifacts 215 remaining in the search results after triangulation. The resulting filtered set of data artifacts 215 are then globally ranked and displayed as explained above. In general, there is no practical limit, other than the obvious limitation of filtering out every data artifact 215, to the number of filters that client user 155 can apply to a search. That is, triangulation can be repeated for multiple selected data artifacts 215.

In cases where a query yields excessive results, it may be difficult to find a specific instance of a search subject because the relevant data artifacts 215 are buried in too much data. For example, the data artifacts 215 associated with Microsoft Chairman Bill Gates are so numerous that they overpower and effectively hide those associated with a less-well-known Bill Gates who lives in Kansas. To address this problem, system 100, in some embodiments, includes a different form of triangulation in which a Boolean “NOT” function excludes, from the original search results, data artifacts 215 that originated from Web pages containing a particular data artifact selected by client user 155. In the “Bill Gates” example just mentioned, client user 155 could search for a “Bill Gates” who is NOT affiliated with Microsoft, which would eliminate a number of irrelevant data artifacts 215 from the search results.

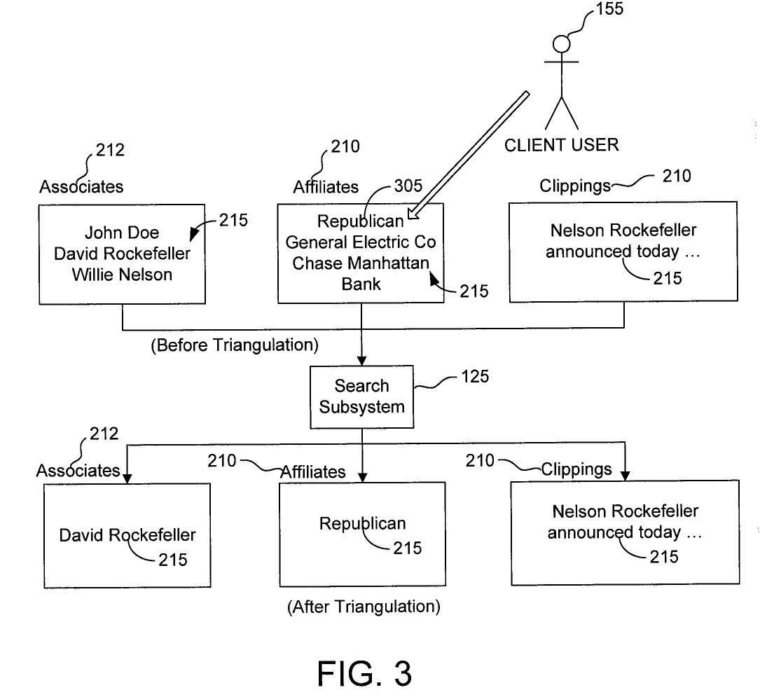

FIG. 4 is a functional block diagram of time-based searching in accordance with an illustrative embodiment of the invention. In this embodiment, system 100 periodically archives the data structures produced by ICI subsystem 120 (e.g., query index 145 in FIG. 1). For example, system 100 may archive the data structures on a daily, weekly, monthly, or annual basis, depending on the particular application. In FIG. 4, current query index 405 is the most recent query index. Previously archived query indexes 410 represent earlier snapshots of the processed Web data corresponding to earlier periods. This gives client user 415 the ability to search for a subject with respect to a specific period of time specified in the search query. For example, a search such as “John Doe circa 2003” submitted to search subsystem 420 may return dramatically different results to user Web-browser display 425 than a search for “John Doe circa 2006” because it is likely that affiliations, hobbies, and other associated data artifacts 215 will have evolved over time.

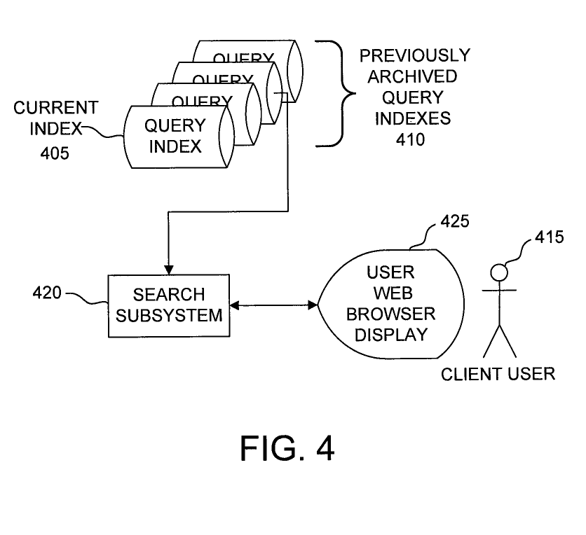

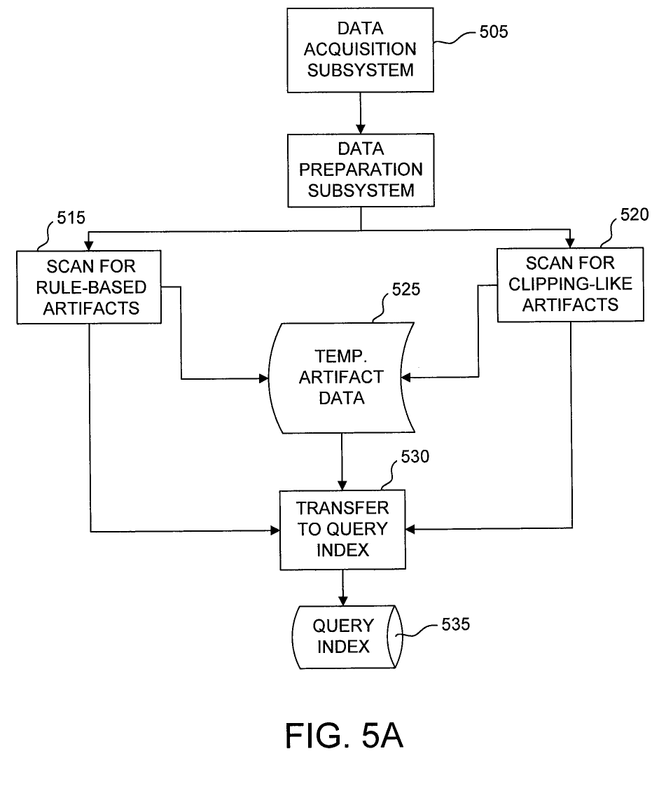

FIG. 5A is a process flow diagram of a process for classifying data artifacts discovered on Web pages in accordance with an illustrative embodiment of the invention. Classification of data artifacts 215 can be implemented in a variety of ways. The embodiment discussed in connection with FIG. 5A is merely one representative example. In this embodiment, classification of data artifacts 215 proceeds in stages. First, a Web page is analyzed to identify one or more data artifacts 215. Second, each identified data artifact 215 is classified as one of a predetermined set of types 210. Third, the classified data artifacts 215 are indexed and organized, by subject, in one or more data structures.

In some embodiments, the Web page is first decomposed into smaller units of data before being analyzed for data artifacts 215. For example, the Web page may be decomposed into “strings,” a contiguous block of text such as a sentence or paragraph bounded by predetermined Web-page delimiters. As a first approximation, a string is simply a sentence or paragraph as viewed on the original Web page. That is, all Web-page definition elements such as HTML tags, etc., have been removed by data acquisition subsystem 505, and the user-visible text is retained. Experiments have shown that the string concept produces natural units of work to classify. As the strings are defined, certain metadata features about the string such as its position on the Web page, its “style” (e.g., fonts, text features, etc.) are determined and become part of the overall classification of data artifacts 215 later on.

Discovery and classification of data artifacts 215 in Blocks 515 and 520 is largely based on the application of rule-based grammar detection elements. In one embodiment, discovery and classification of artifacts 215 in Blocks 515 and 520 is based on a set of context-free grammar rules. This approach avoids the complexity associated with full natural-language processing. For example, a name of a person is discovered by examining a portion of the Web page (e.g., a string) and applying a series of rules carefully constructed to detect the likely appearance of a name. A simple example of a first-order rule is “two contiguous words, each of which begins with an initial capital letter.” This rule can be combined with other rules and a list of recognized names produced by infrastructure support subsystem 110 to classify reliably a data artifact 215 as a name of a person. Analogous rules tailored to the characteristics of each particular data-artifact type 210 and, where applicable, lists produced by infrastructure support subsystem 110 are used to identify other types of data artifacts 215.

Once an artifact has been discovered and classified, it is stored temporarily (Block 525) until ICI subsystem 120 has indexed and organized it in query index 535 (Block 530). For example, the classified data artifact 215 may be stored in random-access memory (RAM) temporarily while other portions of a string or Web page are being examined.

Discovery and classification of data artifacts 215 can yield either a unique result or an overlapped result. A typical unique result is the determination that a data artifact 215 is, for example, a name of a person. Once the classification is made, the same portion of the Web page is not, in this embodiment, additionally classified as another data-artifact type (e.g., a location). On the other hand, once all the data artifacts 215 have been discovered in a portion of the Web page (e.g., a string), it might be the case that some or all of that portion of the Web page is also a clipping or other clipping-like data artifact. It is not unusual for certain data artifacts 215 (typically, a name of a person) to exist inside another data artifact 215 such as a clipping or a biography. ICI subsystem 120 can be designed to handle such overlapping cases as part of its normal duties.

Classification of a data artifact 215 is rarely a simple choice. System 100 is designed to confront discovered data artifacts 215 which may, in fact, appear likely to be any of several different and distinct types 210. For example, a data artifact 215 might be a name of a person, or it might be location. To address this kind of situation, determination of a data-artifact type 210 may include a probabilistic ranking. For example, ICI subsystem 120 might determine that a particular data artifact 215 has about a 60 percent chance of being a name and a 30 percent chance of being a location. Once various probabilistic ranking rules (part of the rules for each data-artifact type 210) have been applied for each potential data-artifact type 210, system 100 selects the data-artifact type 210 based on the highest probabilistic ranking among the various types 210.

The final work product of ICI subsystem 120 is one or more data structures that place the various discovered data artifacts 215 into a high-speed query index 535 that is optimized for efficient, high-speed searching in response to user queries. In one embodiment, at least one data structure contains an entry for each of a set of subjects. Associated and grouped together with each subject, in this embodiment, is a group of pointers that point to the actual data artifacts 215 stored in one or more separate data structures. The one or more data structures containing indexed pointers to data artifacts 215 may be replicated for each kind of subject to be searched, each such data structure being organized around the applicable type of subject (name of a person, location, organization, etc.) to looked up in response to a search query.

One of the challenges in indexing and organizing unstructured data gleaned from Web sites is that of disambiguation. Disambiguation refers to the process of determining with which unique instance of a non-unique subject a particular data artifact 215 is associated. For example, if there are 2000 different people with the name “Bob Smith” mentioned on the Web, associating a geographic location such as “Chicago, Ill.” with a specific Bob Smith is a disambiguation of that location data artifact 215. In some cases, such disambiguation is difficult or even impossible due to a lack of information. In an illustrative embodiment, disambiguation is not attempted during the indexing and organizing of data artifacts 215 by ICI subsystem 120. Instead, disambiguation is postponed until a user invokes the triangulation features of system 100 to focus the search results. This is explained further in connection with FIG. 5B.

FIG. 5B is a diagram showing the association of data artifacts with a single subject entry in the data structures when the subject is non-unique, in accordance with an illustrative embodiment of the invention. Though multiple instances of a subject might exist on the Web (e.g., multiple people with the same name—“Bob Smith”), this embodiment associates with a single subject entry all data artifacts 215 that are associated with such a non-unique subject. In associating data artifacts 215 with a single subject entry, morphological variations of the non-unique subject may be taken into account. For example, in a situation in which there are 2000 Bob Smiths on the Web, all data artifacts 215 associated with all of the various Bob Smiths are associated, in the data structures of system 100, with a single subject entry for “Bob Smith” and its morphological variations such as “Robert Smith,” “Rob Smith,” variations that include a middle name or initial, and so forth.

In FIG. 5B, Web data 540 includes three different Bob Smiths (545, 550, and 555), each having its own associated information (556, 557, 558). In practice, the associations between the three Bob Smiths and their respective information indicated in FIG. 5B might not be at all apparent from the unstructured data found on various Web pages. In this embodiment, ICI subsystem 120 does not attempt to disambiguate information 556, 557, and 558 as this information is identified and classified as various data artifacts 215. After ICI subsystem 120 has processed Web data 540, the data artifacts 215 corresponding to information 556, 557, and 558 are all associated with a single “Bob Smith” subject entry 560 in data structure 565. Search subsystem 125 can then assist with disambiguation via its triangulation capabilities, as described above.

Several representative data-artifact types 210 and search-result categories 212 will now be described in greater detail. As mentioned above, any of the various data-artifact types 210 can be treated as a subject in building query index 535 and in retrieving search results. The following descriptions are based on an embodiment in which a subject is a name of a person, but the same principles apply to other embodiments in which the search subject is a different type 210 of data artifact 215 or in which a user may select from among multiple available types of search subjects when submitting a query.

Directory. In some embodiments, system 100 includes a “directory” search-result category 212 and corresponding display area (panel) within the displayed search results (see, e.g., FIGS. 2A and 2B) for displaying name artifacts 215 that are associated with the search subject. In effect, the user can thumb through a directory of information of selected people by simply entering the name of the person of interest. Regardless of the number of returned data artifacts 215, the directory-results panel (see 220 in FIGS. 2A and 2B) lists all returned data artifacts 215 that in some sense match the search subject. These could include, for example, data artifacts 215 classified as a name of a person that, taking into account morphological variations, correspond to the search subject. In some embodiments, associated addresses and phone numbers are also included with the names in the directory-results panel.

Location. Where available, system 100 uses third-party sources and the Web pages themselves to extract and present location data associated with a search subject (see, e.g., 225 in FIGS. 2A and 2B). Examples of location data artifacts 215 include, without limitation, a complete street address, city, state, postal code, and country; a geographical or place name such as Yellowstone Park or Cherry Creek Mall; and a Standard Metropolitan Statistical Area (SMSA) such as Aguadilla or Puerto Rico.

Associate. Associates are data artifacts 215, other than the search subject itself, that are classified as a name of a person and that are likely to be associated with the indicated search subject (see, e.g., 226 in FIGS. 2A and 2B). In one embodiment, associates are returned as a search-result category 212 despite the absence of an “associate” data-artifact type 210 in ICI subsystem 120 as ICI subsystem 120 builds query index 535. Instead, in this embodiment, search subsystem 125 determines that a particular data artifact 215 classified as a name of a person is likely to be associated with the search subject during the processing of the search query. Search subsystem 125 can do so by considering the relationship between the particular data artifact 215 and the search subject on the Web pages that have been analyzed.

For example, a search for “John F. Kennedy” reveals “Jackie Kennedy” as an associate because the Web pages that contain the John Kennedy name may contain a Jackie Kennedy name entry on the same Web page, and system 100 has determined (correctly) that the two names are somehow related. Conversely, searching for “Jackie Kennedy” would reveal that “John F. Kennedy” is an associate.

Affiliation. Affiliations are represented as data artifacts 215 that are likely to be associated with the indicated search subject and that are likely to be a company or other organization with which the search subject is associated (see, e.g., 227 in FIGS. 2A and 2B). For example, a search for “John Kennedy” reveals “Democrat” as an affiliation because the pages that contain the John Kennedy name may contain a Democrat entry on the same Web page, and the invention has determined (correctly) that the Democratic Party is an organization with which John Kennedy is associated. Affiliations encompass a large variety of relationships and include, without limitation, companies, organizations, churches, special interest groups, political parties, and many other types of organizations.

Clippings. Clippings are Web-page selections of indeterminate length representing things that have been written by or about the search subject (see, e.g., FIGS. 2C and 3). For example, a data artifact 215 containing a phrase similar to “Patrick Henry said . . . ” is illustrative of a clipping and could be classified as such by ICI subsystem 120. Clippings represent a general category of unstructured information. More specific types 210 of unstructured information include, for example, biographies and education (an information item concerning a person's education).

URLs. Some embodiments of the invention discover, rank, and display a hyperlink to every Web page that potentially contains information of interest about a search subject (see, e.g., FIG. 2C). In one embodiment, these URLs are not assigned a data-artifact type 210 by ICI subsystem 120 during classification. Rather, they are data artifacts 215 that are displayed as a search-result category 212 in response to a query. In this embodiment, the URLs are simply a list of Web pages that participated in the final search results. These URLs are presented to the user for immediate click-through to the specific URL of interest. URLs may be accompanied by a short summary for ease of review and referral to the user. URLs may also be ranked and displayed in order of their relevance to the search subject, as explained above. Techniques for ranking URLs include frequency of use on a Web page, style of name presentation, proximity to the top of the page, and other characteristics.

Education. ICI subsystem 120 analyzes Web pages for a subject in order to determine, where feasible, the educational background of that subject. In some embodiments, search subsystem 125 displays data artifacts classified as “education clippings” in a dedicated pane. These education clippings may be derived via natural language processing that determines that a sentence about a subject (even if only referred to by first or last name, a pronoun, etc.) contains educational information about that subject.

Tags. System 100 discovers, ranks, and displays miscellaneous information about a search subject as a “tag” data artifact 215 (see, e.g., 228 in FIGS. 2A and 2B). Tags represent an important method for discovering things about a subject that otherwise would not be strictly classifiable as one of the standard data-artifact types 210. Experiments have shown that there is a wealth of miscellaneous and unpredictable information that nevertheless yields useful discriminators when one is searching a particular subject. For example, a search for the subject “Thomas Cech” would yield a tag data artifact 215 for Dr. Cech's Nobel Prize, a data item that would not have fit into any of the other data-artifact types 210. In identifying tags, system 100 may apply tailored ranking techniques to strike a balance between useful tag information and extraneous tag-like information that need not appear in the final search results.

Identifiers. System 100 may also discover, classify, and rank identifier data associated with a manner of electronically contacting a person. Such identifiers include, without limitation, e-mail addresses, instant-messaging user IDs, voice-over-Internet-protocol (VoIP) identifiers, phone numbers, and so forth.

Hobbies and Interests. To the extent that they are present in Web data, system 100 may also discover and rank hobbies and other interests that characterize a subject. This may be accomplished, for example, via a fuzzy match of Web-page text associated with the subject against a database of hobby and interest keywords and phrases obtained from infrastructure support subsystem 110.

Biographies. System 100 may also discover and present biographical data in a search-result pane whenever it can discovered about a search subject. The biographical data is clipping-like information that is extracted based on rules designed to identify such biographical data.

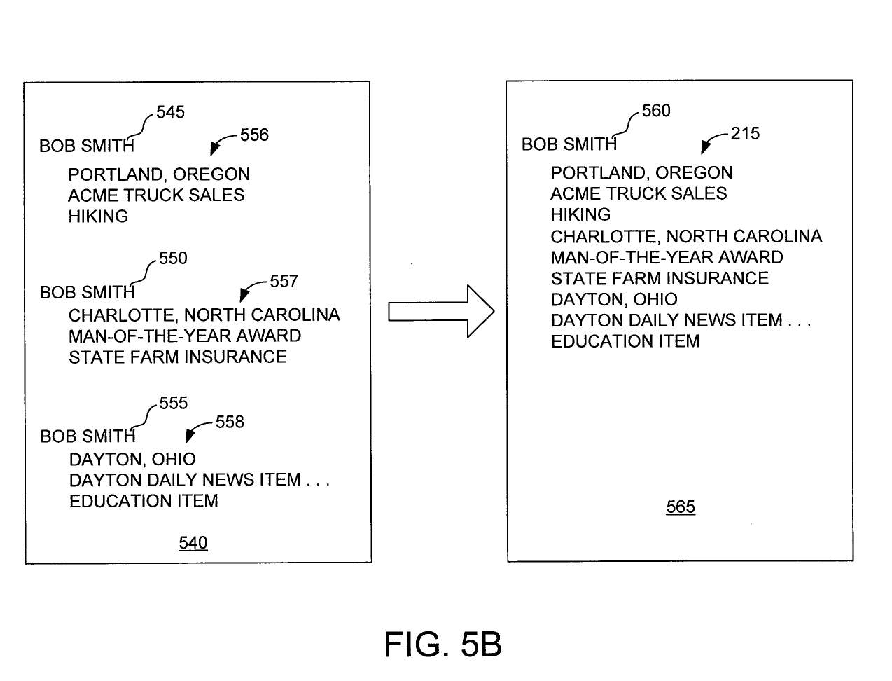

FIG. 6 is a diagram of data importation and exportation in accordance with an illustrative embodiment of the invention. In some cases, a client user 155 might wish to export the search results for further processing. In some embodiments, the invention provides a simple selection of export options to allow the client user 155 to export selected search queries, search results, or both (605) to a network destination specified by client user 155.

In some embodiments, the invention provides the ability to import one or more search queries 610 to search subsystem 125.

Similarly, users, particularly businesses, might want to submit their own lists of subjects (search data 615 in FIG. 6) to system 100 to obtain sets of search results associated with the respective subjects (e.g., names of people) on a given list. Then, using the data-exportation feature, a business can export specific data artifacts 215 for further processing. For example, a business might want to import a list of names and retrieve all of the hobbies of associated with the people on the list to support a targeted mailing. In some embodiments, system 100 provides a standard Web wizard to guide the importation of a user-supplied list to system 100.

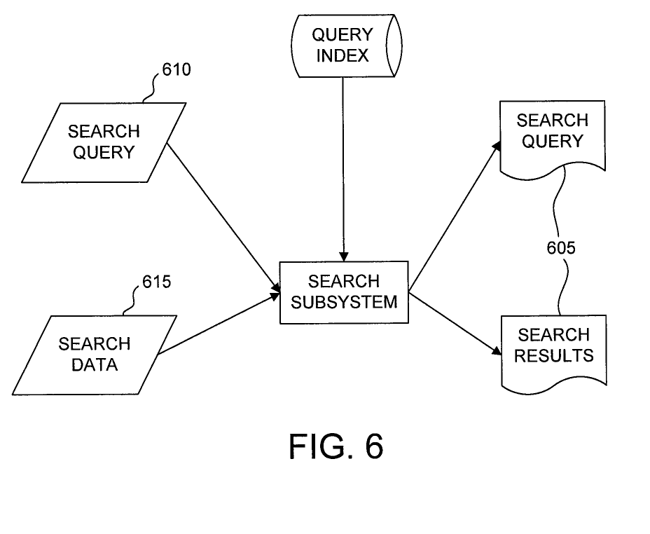

FIG. 7 is a diagram of Web-based application programming interfaces (APIs) in accordance with an illustrative embodiment of the invention. In general, the API set included in this embodiment is offered to allow third-party users 705 to construct simple programmatic interfaces to system 100 within their own applications to harness the power of system 100 for their own user-defined purposes. In this embodiment, the invention is fully available as a “people search” engine to interested third parties, especially businesses. As such, this embodiment includes APIs 710 and accompanying documentation to enable third parties 705 to use all or portions of its search capabilities. In one version of this embodiment, all system features are available via the Web APIs, including the import/export features discussed in connection with FIG. 6.

The APIs of this illustrative embodiment closely follow the task structure offered for a user-driven interactive search. That is, programmatic interfaces are offered to allow the third party 705 to present a sequence of search request atoms and connectors of arbitrary complexity. Triangulation APIs allow the third-party 705 to select specific data-artifact types 210 and data artifacts 215 for subsequent narrowing of the search results. Additional APIs allow the third party 705 to summon an import wizard to import query lists for a search. Export APIs allow the third party 705 to request the creation of simple text files containing search query requests, search results, or both.

Some versions of the foregoing embodiment may also include built-in safeguards that constrain the uses of the APIs to forestall excessive data mining and similar activities.

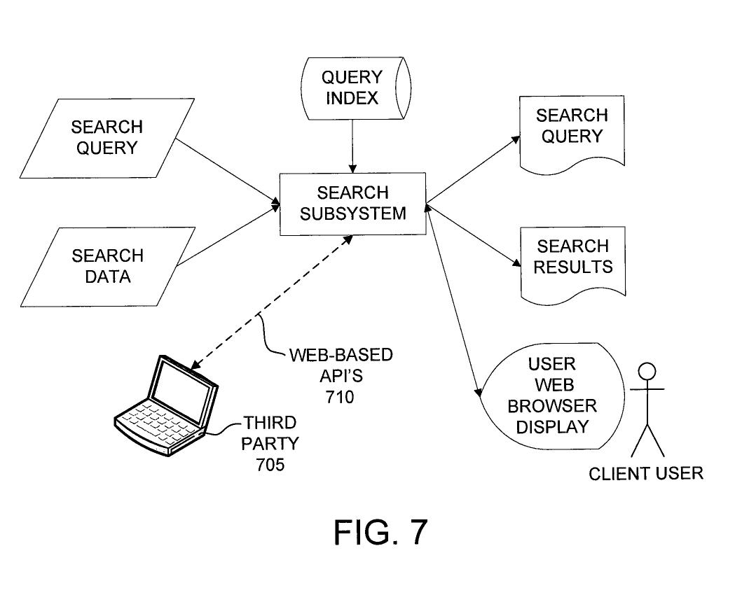

FIG. 8 is a diagram of a distributed search architecture 800 in accordance with an illustrative embodiment of the invention. To offer a rapid response to requests from a client computer 805 associated with a client user 810, search subsystem 125, in this embodiment, is designed to be distributed over multiple servers 815 and search routers 820 and to use distributed versions of the query index 825 built by ICI subsystem 120. To keep up with the work load of an ever-changing Web, ICI subsystem 120 may also be designed to be distributed over multiple servers to take advantage of parallel processing techniques.

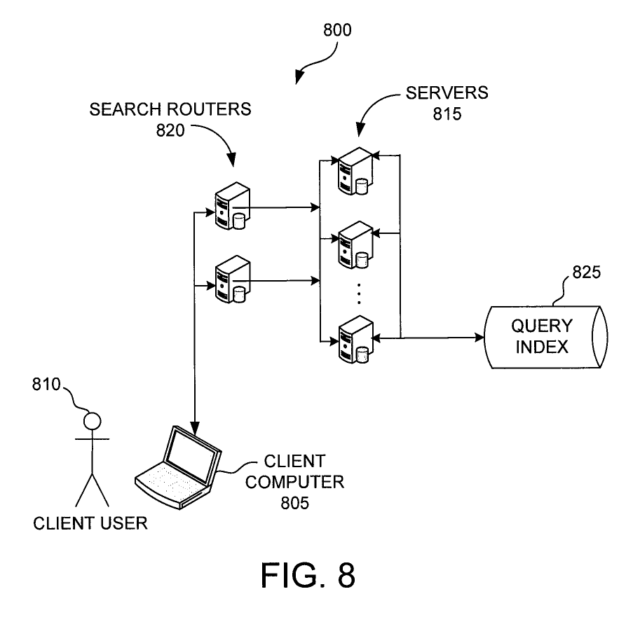

FIG. 9 is a flowchart of a method for collecting information from Web sites in accordance with an illustrative embodiment of the invention. At 905, data acquisition subsystem 105 acquires a collection of Web pages as explained above. For each Web page in the collection of Web pages, Blocks 910, 915, and 920 are performed. At 910, ICI subsystem 120 analyzes the Web page for one or more data artifacts 215. ICI subsystem 120, at 915, classifies each discovered data artifact 215 as one of a predetermined set of types 210. At 920, ICI subsystem 120 indexes and organizes each classified data artifact 215, associating each classified data artifact 215 with a subject. If there are no more Web pages to process at 925, the process terminates at 930.

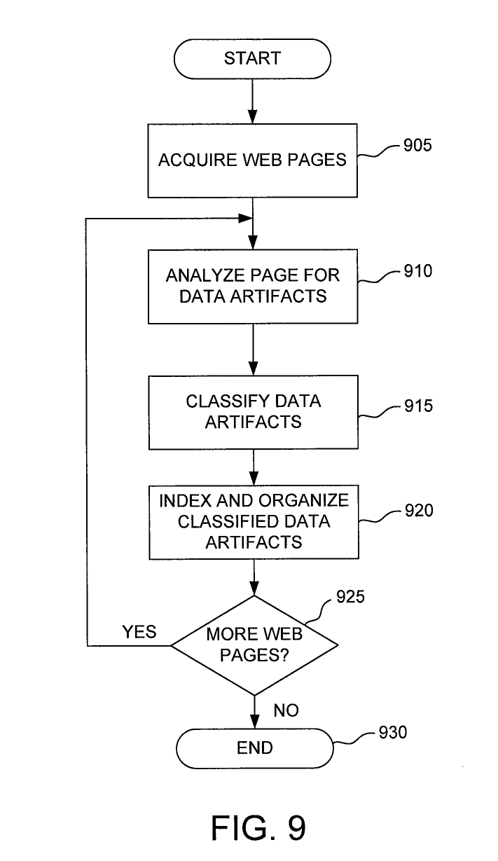

FIG. 10 is a flowchart of a method for collecting and retrieving information from Web sites in accordance with another illustrative embodiment of the invention. In this embodiment, the method proceeds as described in connection with FIG. 9 through Block 925. At 1005, search subsystem 125 receives a query from a client user 155 indicating a particular subject to be searched. At 1010, search subsystem 125 retrieves search results from query index 145, the search results including a set of data artifacts 215 associated with the particular subject. If the particular subject is not found in query index 145, search subsystem 125 outputs a suitable message to client user 155 indicating that no search results were found. If search results were found at 1010, search subsystem 125 displays at least some of the search results at 1015. As described above, search subsystem 125 may group the data artifacts 215 in the search results by their respective types 210 and display the data artifacts 215 within each type 210 in descending order of relevance to the particular subject based on a global ranking system. At 1020, the process terminates.

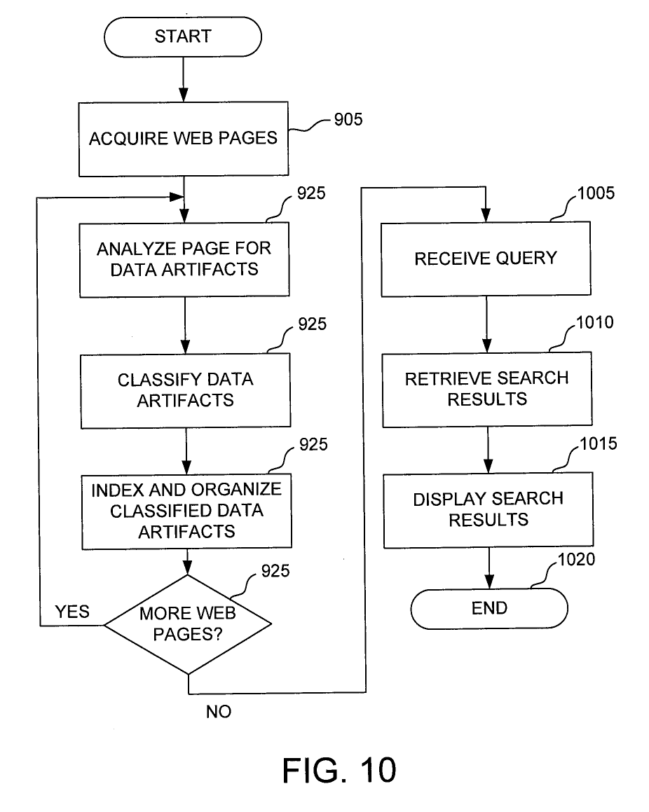

FIG. 11 is a flowchart of a method for collecting and retrieving information from Web sites in accordance with another illustrative embodiment of the invention. In this embodiment, the method proceeds as in FIG. 10 through Block 1015. At 1105, search subsystem 125 limits the search results to data artifacts 215 from Web pages that contain a particular data artifact 215 selected by client user 155 from among the original search results. Search subsystem 125 can perform this triangulation process in serial or parallel fashion for multiple selected data artifacts 215, the effect of the selection of multiple data artifacts 215 being a cumulative Boolean “AND” function. At 1110, the process terminates.

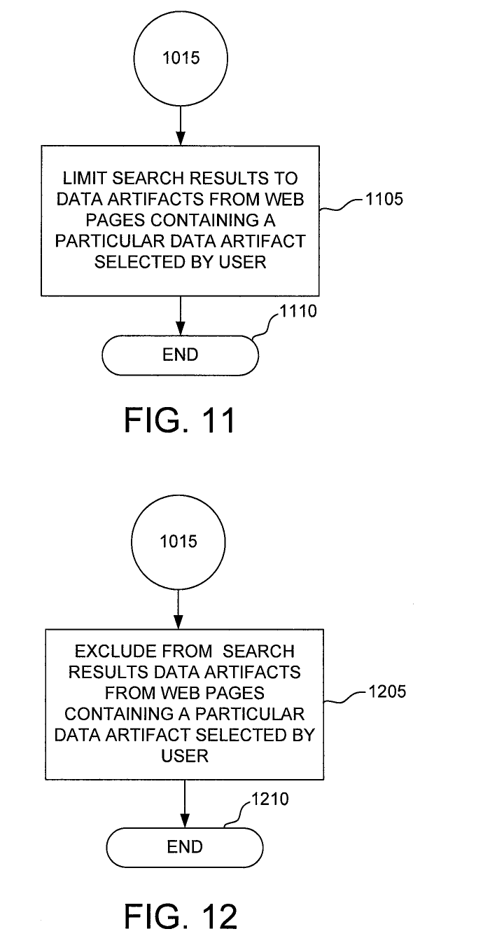

FIG. 12 is a flowchart of a method for collecting and retrieving information from Web sites in accordance with yet another illustrative embodiment of the invention. In this embodiment, the method proceeds as in FIG. 10 through Block 1015. At 1205, search subsystem 125 excludes from the search results data artifacts 215 from Web pages that contain a particular data artifact 215 selected by client user 155 from among the original search results. Search subsystem 125 can perform this triangulation operation in serial or parallel fashion for multiple selected data artifacts 215, the effect of the selection of multiple data artifacts 215 being a cumulative Boolean “NOT” function. At 1210, the process terminates.

In some embodiments, a user may select between the two triangulation modes described above prior to or in conjunction with selecting a particular data artifact 215.

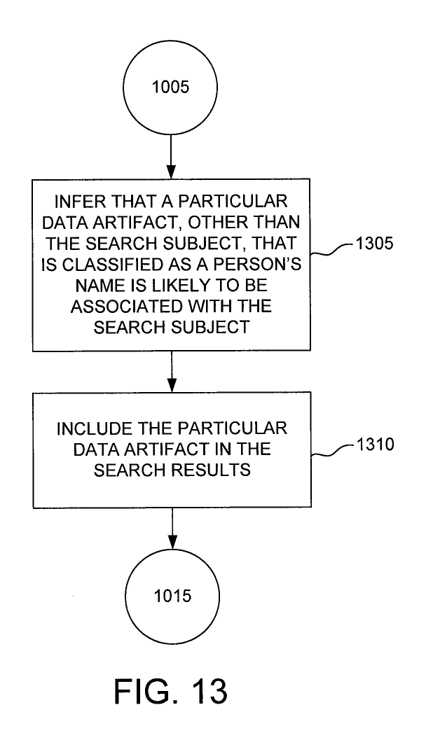

FIG. 13 is a flowchart of a method for associating a data artifact with a search subject in accordance with an illustrative embodiment of the invention. As explained above, in some embodiments of the invention, not all search-results output by search subsystem 125 correspond directly to data-artifact types 210 assigned by ICI subsystem 120 during the classification process. For example, associates—names of people likely to be associated with a subject—are determined by search subsystem 125 during the processing of a query in these embodiments. FIG. 13 shows a method that can be applied in conjunction with the retrieving of search results at Block 1010 in FIG. 10.

At 1305, search subsystem 125 infers that a particular data artifact 215, other than the search subject itself, that is classified as a person's name is likely to be associated with the search subject. At 1310, this particular data artifact 215 is included in the search results that are output by search subsystem 125 at Block 1015 in FIG. 10. For example, such a data artifact 215 can be displayed in a ranked list of “associates” in an associates pane (see, e.g., 226 in FIGS. 2A and 2B). As explained above, the inference at 1305 can be based on the joint occurrence of the search subject and the particular data artifact 215 on the same Web page, the proximity of the two names on that Web page, or other factors.

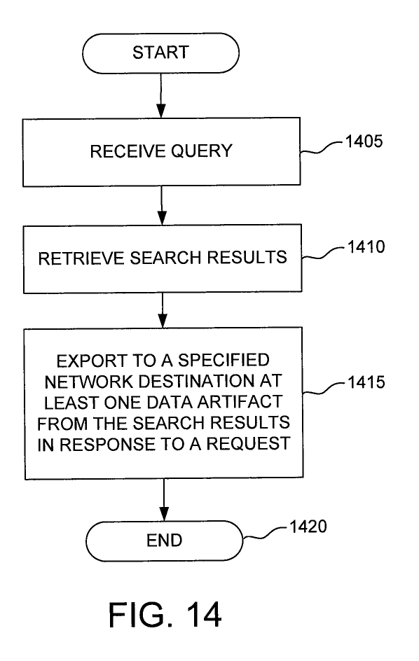

FIG. 14 is a flowchart of a method for exporting search results in accordance with an illustrative embodiment of the invention. At 1405, search subsystem 125 receives a query from a client user 155 indicating a particular subject to be searched. At 1410, search subsystem 125 retrieves search results from query index 145, the search results including a set of data artifacts 215 associated with the particular subject. At 1415, search subsystem 125 exports, to a specified network destination, at least one data artifact 215 from the search results in response to a request from the client user 155. In some embodiments, search subsystem 125 can output a search query itself in addition to or instead of one or more data artifacts 215 from the search results. At 1420, the process terminates.

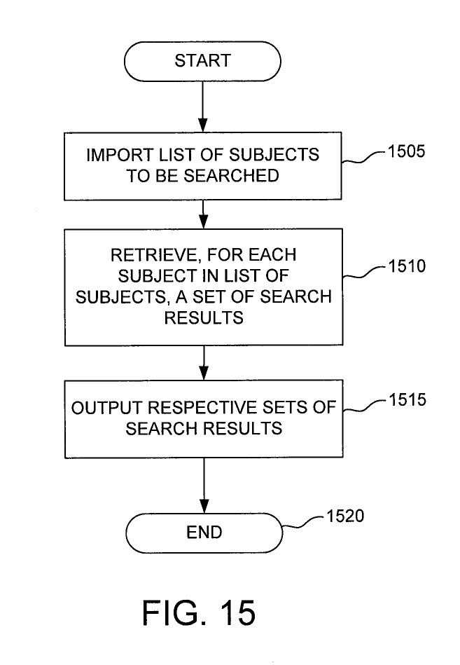

FIG. 15 is a flowchart of a method for importing search queries in accordance with an illustrative embodiment of the invention. At 1505, search subsystem 125 imports, from a client user 155, a list of subjects to be searched. At 1510, search subsystem 125 retrieves, for each subject in the list of subjects, a set of search results for that subject. Each set of search results includes a set of data artifacts 215 associated with the corresponding subject. At 1515, search subsystem 125 outputs the sets of search results associated with the respective subjects in the list of subjects. The process terminates at 1520.

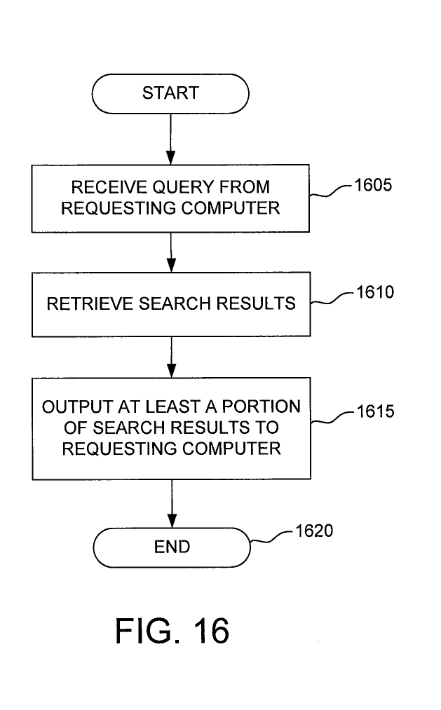

FIG. 16 is a flowchart of a method for processing a request for information collected from Web sites in accordance with an illustrative embodiment of the invention. At 1605, search subsystem 125 receives, from a requesting computer (e.g., a client computer associated with a client user 155), a search query indicating a particular subject to be searched. At 1610, search subsystem 125 retrieves, from data structures such as query index 145, search results including a set of data artifacts 215 associated with the particular subject. At 1615, search subsystem 125 outputs, to the requesting computer, at least a portion of the search results retrieved at 1610. The output can be, for example, displayed search results on user Web-browser display 160, one or more exported files or data structures, or both. At 1620, the process terminates.

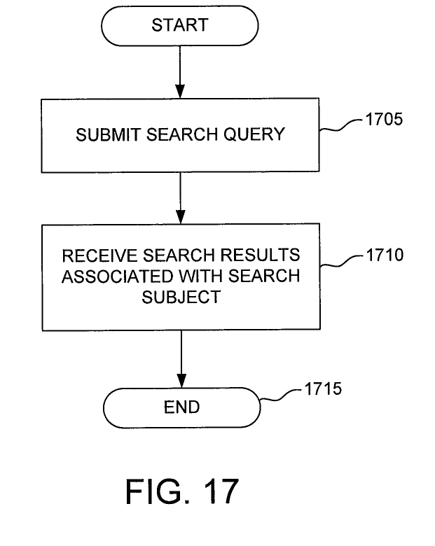

FIG. 17 is a flowchart of a method for obtaining information collected from Web sites in accordance with an illustrative embodiment of the invention. At 1705, a client user 155 submits, to search subsystem 125 over a network such as the Internet, a search query indicating a particular subject to be searched. At 1710, client user 155 receives search results from search subsystem 125, the search results including a set of data artifacts 215 associated with the particular subject. At 1715, the process terminates.

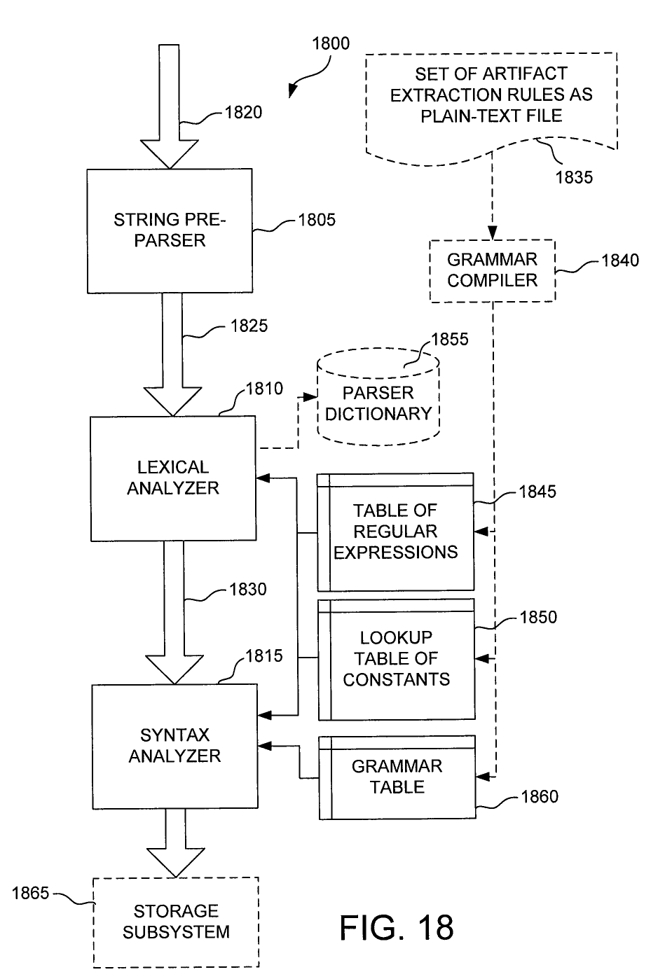

FIG. 18 is a functional block diagram of an ICI subsystem 1800 in accordance with an illustrative embodiment of the invention. ICI subsystem 1800 analyzes on-line data objects to discover, classify, rank, and store data artifacts 215 for subsequent retrieval in response to a search query for a particular subject, as explained above. On-line data objects include, without limitation, Web pages, Usenet postings, e-mail messages, and Web feeds (e.g., RSS feeds).

Once data acquisition subsystem 105 has converted the data in an on-line data object (e.g., a Web page) into a canonical form by decomposing the data into strings, the strings are passed to ICI subsystem 1800. As explained above, data preparation subsystem 115 may optionally remove duplicate on-line data objects using time stamps, a “fingerprint” (e.g., a hash value) of an on-line data object's contents, or other features that identify redundant data.

In the illustrative embodiment of FIG. 18, ICI subsystem 1800 has been divided into three main functional modules: string pre-parser 1805, lexical analyzer 1810, and syntax analyzer 1815.

String pre-parser 1805 divides input strings 1820 into individual characters. That is, string pre-parser 1805 divides each input string 1820 into a set of separate characters 1825. The sets of separate characters 1825 are rendered in a canonical form compatible with a predetermined target language (e.g., English). In other embodiments, string pre-parser 1805 may be configured for languages other than English.

Lexical analyzer 1810 aggregates each set of separate characters 1825 produced by string pre-parser 1805 into a sequence of tokens 1830. In some embodiments, only the text content of a set of separate characters 1825 is aggregated into tokens, not the associated metadata. Each atomic token roughly corresponds to a word or a delimiter such as a punctuation symbol or an HTML tag. In some embodiments, “word” loosely refers to a group of contiguous characters delimited by white space, punctuation marks, or both. In such embodiments, “word” includes groups of contiguous characters that might not necessarily be found in a dictionary. Examples of “words,” under this definition, include, without limitation, acronyms (e.g., “HTML”), groups of contiguous characters containing an underscore character (e.g., “JOHN_DOE”), numerals (e.g., “100”), and section numbers (e.g., “10.2”) in a technical document. Tokenization proceeds according to a set of rules regarding white space separators between words, punctuation, etc. The end result of tokenization is an ordered sequence of tokens 1830 corresponding to the words and punctuation symbols contained in the original string 1820.

Each token has three elements in this illustrative embodiment: (1) token type, which is one of “word” (sequence of letters), “punctuator” (any single punctuation symbol), or “tag” (HTML tag in angle brackets); (2) token value (the content or value of the token); and (3) token offset (e.g., in bytes from the start of the string). In other embodiments, additional elements may be associated with a given token, and additional token types such as “number” may be defined.

One aspect of lexical analyzer 1810 is the implementation of the “lexical” part of the compiled rule set as a list of regular expressions and lookup tables. Lexical analyzer 1810 parses the canonical strings from string pre-parser 1805 by the use of “regular expressions,” a term well known in the computing art. Regular expressions are recognized by the use of rules obtained from a plain-text set of rules 1835 that are compiled by grammar compiler 1840 into a suitable table of regular expressions 1845 for use by lexical analyzer 1810. Typical rules are structured to allow the system to recognize various constructs of a given token such as a title-case rule, a single-letter rule, etc. Other lexical rules are easily recognized by those skilled in the art. The syntax of the rules is further explained below.

Lexical analyzer 1810 associates with each token one or more token subtypes (e.g., a token such as “Inc” might have associated subtypes “<Title Case>” and “<Company Name Suffix>”). Subtypes are used later by syntax analyzer 1815, which implements a compiled grammar.

As an illustrative example, suppose that lexical analyzer 1810 is presented with the string “Doe, John”. The lexical analyzer 1810 will produce three tokens as follows:

1. <WORD value=“Doe”, subtype=“TitleCase;LastName”, offset=XXX>

2. <PUNCTUATOR value=“,”, subtype=“Comma”, offset=XXX>

3. <WORD value=“John”, subtype=“TitleCase;FirstName”, offset=XXX>.

It should be recognized that the system may occasionally be confronted with tokens that have multiple subtypes. For example, a text string corresponding to a geographic location such as “Ft. Smith, Arkansas” exhibits an obvious ambiguity of the “Smith” token because “Smith” is a common last name. Lexical analyzer 1810 may produce several possible subtypes for such tokens in the following form:

<WORD value = “Smith”, subtype = “TitleCase;LastName;FirstName;2nd
word of City”, offset = XXX>.

### Resolution of such a token is performed later during the syntax analysis phase.

In this illustrative embodiment, lexical analyzer 1810 assigns one or more subtype codes to each token. Lexical analyzer 1810 refers to a lookup table of constants 1850 to determine tentative classifications of a token. For example, common token fragments such as “Ft”, “San”, “Los”, and many others are contained in a list of classifiable subtypes. At a minimum, lexical analyzer 1810 recognizes, but is not limited to, the following subtypes listed in Table 1:

TABLE 1

| Token Type | | |
|---|---|---|
| Number | Token Subtype | Example |
| 40 | PUNCT: Left Bracket | ( |
| 41 | PUNCT: Right Bracket | ) |
| 44 | PUNCT: Comma | , |
| 45 | PUNCT: Dash | - |
| 46 | PUNCT: Full Stop | . |
| 128 | WORD: Complex Title Case | McDonalds |
| 129 | WORD: Company Suffix | Ltd |
| 130 | WORD: P (1^{st} part of company suffix P.C.) | P |
| 131 | WORD: C (2^{nd} part of company suffix P.C.) | C |
| 132 | WORD: Initial (one uppercase letter) | A |
| 133 | WORD: Subject Name Prefix | Mr |
| 134 | WORD: Subject Name Suffix | Jr |
| 135 | WORD: ST (1^{st} part of 2-word “saint” city name) | St |
| 136 | WORD: SAINT (1^{st} part of 2-word “saint” city name) | Saint |
| 137 | WORD: FT (1^{st} part of 2-word “fort” city name) | Ft |
| 138 | WORD: FORT (1^{st} part of 2-word “fort” city name) | Fort |
| 161 | WORD: Article | the |
| 162 | WORD: Preposition | in |
| 163 | WORD: Terminator | is |
| 164 | WORD: Single-word tag | CEO |
| 171 | WORD: is | is |
| 172 | WORD: was | was |
| 173 | WORD: said | said |
| 174 | WORD: by | by |
| 175 | WORD: contact | contact |
| 176 | WORD: has | has |
| 177 | WORD: to | to |
| 178 | WORD: Verb in the past | discussed |
| 179 | WORD: Verb in third person | guesses |
| 200 | WORD: First Name | John |
| 201 | WORD: Last Name | Smith |
| 300 | WORD: Single-Word State Name/Abbreviation | Colorado |
| 308 | WORD: NEW (1^{st} word of “new” state names) | New |
| 309 | WORD: NEW-* (2^{nd} word of “new” state names) | Jersey |
| 311 | WORD: Single-Word City Name | Denver |
| 318 | WORD: NORTH (1^{st} word of “north” state names) | North |
| 319 | WORD: NORTH-* (2^{nd} word of “north” state names) | Carolina |
| 321 | WORD: 1^{st} Word of 2-word City Name | Los |
| 322 | WORD: 2^{nd} Word of 2-word City Name | Angeles |
| 328 | WORD: *-Dak (1^{st} word of “No Dak” state abbr.) | No |
| 329 | WORD: No-* (2^{nd} word of “No Dak” state abbr.) | Dak |
| 331 | WORD: 1^{st} Word of 3-word City Name | Bear |
| 332 | WORD: 2^{nd} Word of 3-word City Name | River |
| 333 | WORD: 3^{rd} Word of 3-word City Name | City |
| 338 | WORD: *-Island (1^{st} word of “Rhode Island” state name) | Rhode |
| 339 | WORD: Rhode-* (2^{nd} word of “Rhode Island” state abbr.) | Island |
| 348 | WORD: SOUTH (1^{st} word of “south” state names) | South |
| 349 | WORD: SOUTH-* (2^{nd} word of “south” state names) | Dakota |
| 358 | WORD: WEST (1^{st} word of “west” state names) | West |
| 359 | WORD: WEST-* (2^{nd} word of “west” state names) | Virginia |
| 361 | WORD: 1^{st} Word of 2-word City Name with Hyphen Inside | Lexington |
| 362 | WORD: 2^{nd} Word of 2-word City Name with Hyphen Inside | Fayette |
| 365 | WORD: 1^{st} Word of 3-word City Name “Salt lake City” | Salt |
| 366 | WORD: 2^{nd} Word of 3-word City Name “Salt lake City” | Lake |
| 367 | WORD: 1^{st} Word of 3-word City Name “Salt lake City” | City |
| 368 | WORD: 1^{st} Word of 2-word City Name “Las Vegas” | Las |
| 369 | WORD: 2^{nd} Word of 2-word City Name “Las Vegas” | Vegas |
| 372 | WORD: 2^{nd} Word of “saint” City Name | Louis |
| 377 | WORD: 1^{st} Word of 3-word Region Name “District of | District |
| | Columbia” | |
| 378 | WORD: 2^{nd} Word of 3-word Region Name “District of | of |
| | Columbia” | |
| 379 | WORD: 3^{rd} Word of 3-word Region Name “District of | Columbia |
| | Columbia” | |
| 382 | WORD: 2^{nd} Word of “fort” City Name | Benton |

Numerous other fragments and subtypes are easily recognized by those skilled in the art. Thus, lexical analyzer 1810 identifies various token subtypes within the canonical strings from string pre-parser 1805 by the use of lookup table of constants 1850. Lookup table of constants 1850 is obtained from a plain-text set of subtypes 1835 that is compiled by grammar compiler 1840 into a suitable tabular format for use by lexical analyzer 1810.

In some embodiments, ICI subsystem 1800 employs a parser dictionary 1855 as an adjunct to the main operations of lexical analyzer 1810. Parser dictionary 1855 serves as a cache buffer to speed up certain local operations during lexical processing.

Discovery of data artifacts 215 is accomplished by one or more scans of each token sequence 1830. For various reasons, certain data artifacts 215 are not discovered during the first pass over the tokens. For example, tag data artifacts 215 are discovered in a second pass after the first pass has discovered the more structured types of data artifacts 215. The discovery of tag data artifacts 215 is postponed because, by definition, tag data artifacts 215 are those items of interest that remain after the other data artifacts 215 have been discovered and classified. Finally, text-block data artifacts 215 such as clippings, educational items, and biographies are discovered in a third pass after all other data artifacts 215 have been discovered. ICI subsystem 1800 includes the capability of recognizing previously identified data artifacts 215 during later passes over the input data. In this manner, the same data artifact 215 is not discovered more than once.

Performing multiple passes over the sequences of tokens allows ICI subsystem 1800 to discover an “outer” data artifact 215 that contains within it one or more previously discovered data artifacts 215. For example, a clipping data artifact 215 may contain a previously discovered affiliation data artifact 215.

Syntax analyzer 1815 applies a body of grammar rules to the output 1830 of lexical analyzer 1810 to discover data artifacts 215. In this illustrative embodiment, the grammar rules are obtained from a plain-text set of syntax rules 1835 that is compiled by grammar compiler 1840 into a suitable tabular format, grammar table 1860, for use by syntax analyzer 1815. In its multiple passes over the sequences of tokens 1830, syntax Analyzer 1815 applies different rule and parsing sets as exemplified by different sets of driver tables—table of regular expressions 1845, lookup table of constants 1850, and grammar table 1860.

Each rule set corresponds to a particular data-artifact type 210 among a predetermined set of distinct data-artifact types 210 and is tailored to the discovery of data artifacts 215 of that particular type 210. In some embodiments, each rule set includes both a grammar to detect the likely occurrence of a data artifact 215 of the corresponding type 210 and predetermined data values to guide the determination of the probability ranking of the data artifact 215. In one illustrative embodiment, at least one rule set among the various rule sets includes a context-free grammar.

One or more tokens, in a sequence of tokens, satisfying the rule set corresponding to a particular data-artifact type 210 qualify as a “candidate data artifact” of that type 210. A token or group of tokens may qualify as a candidate data artifact for multiple data-artifact types 210. As will be discussed in further detail below in connection with probability rankings, syntax analyzer 1815 applies the grammar rules and other heuristics to estimate, for each candidate data artifact, the most probable data-artifact type 210 and classifies the candidate data artifact as a data artifact 215 of that type 210. Syntax analyzer 1815 then passes on its ultimate classifications of the data artifacts 215 and the elements of those data artifacts 215 to storage subsystem 1865.

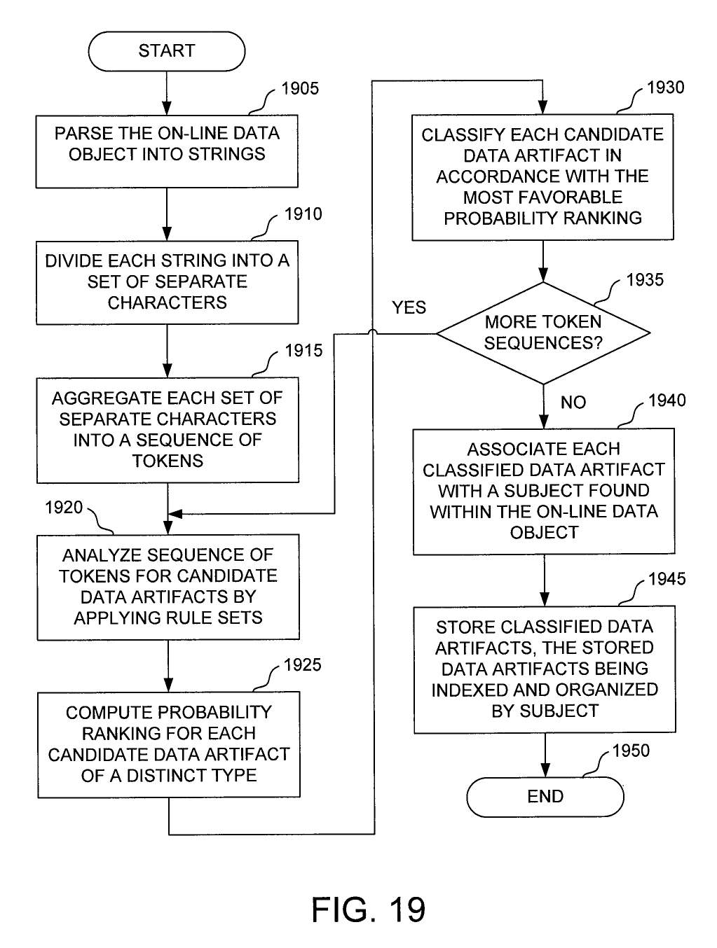

FIG. 19 is a flowchart of a method for discovering data artifacts in an on-line data object in accordance with an illustrative embodiment of the invention. FIG. 19 summarizes the operation of ICI subsystem 1800. At 1905, data acquisition subsystem 105 parses an on-line data object into one or more strings. At 1910, string pre-parser 1805 divides each string into a set of separate characters 1825. At 1915, lexical analyzer 1810 aggregates each set of separate characters into a sequence of tokens 1830.

At 1920, syntax analyzer 1815 applies to each sequence of tokens 1830 the rule sets associated with the various data-artifact types 210 to determine, for each data-artifact type 210, whether the sequence of tokens 1830 contains one or more candidate data artifacts of that data-artifact type 210. At 1925, syntax analyzer 1815 computes, for each candidate data artifact of a particular type found within the sequence of tokens 1830, a probability ranking indicating how likely the candidate data artifact is to be a data artifact of that distinct type 210. At 1930, syntax analyzer 1815 classifies each candidate data artifact in accordance with the most favorable probability ranking computed for that candidate data artifact.

If there are more sequences of tokens from the current on-line data object to process at 1935, the process returns to Block 1920. Otherwise, syntax analyzer 1815, at 1940, associates each classified data artifact 215 with a subject found within the same on-line data object. At 1945, the classified data artifacts 215 are stored in storage subsystem 1865. The classified data artifacts 215 are indexed and organized by subject in storage system 1865, as described above. At 1950, the process terminates.

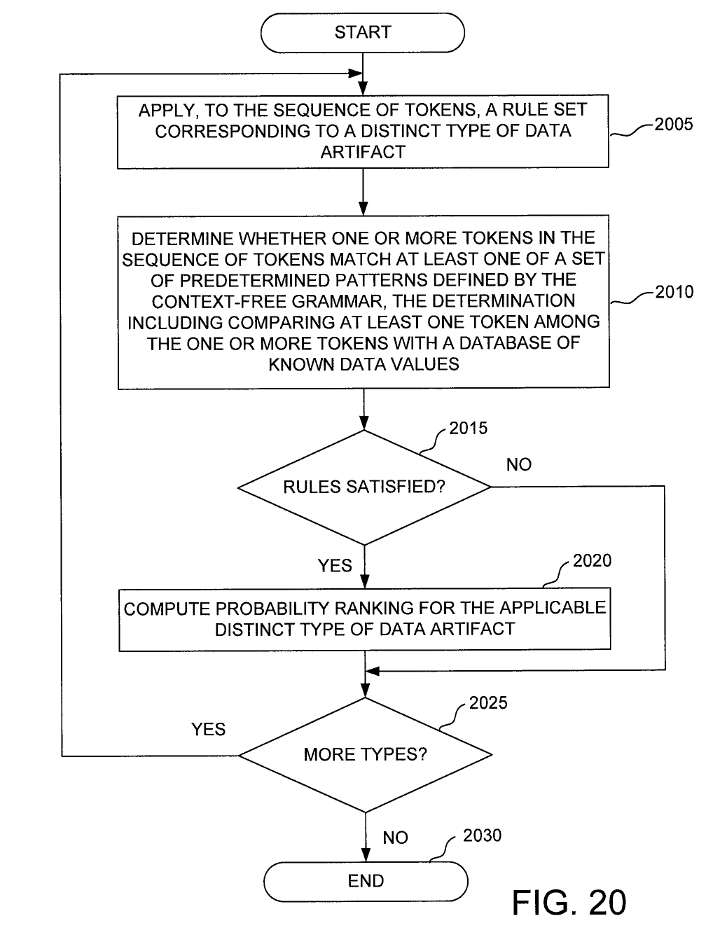

FIG. 20 is a flowchart of a method for applying, to a sequence of tokens 1830, each of a plurality of rule sets, each rule set corresponding to a distinct type of data artifact 210, in accordance with an illustrative embodiment of the invention. At 2005, syntax analyzer 1815 applies, to a sequence of tokens 1830, a rule set corresponding to a distinct type 210 of data artifact 215. At 2010, syntax analyzer 1815 determines whether one or more tokens in the sequence of tokens match one or more predetermined patterns defined by the context-free grammar of the applicable rule set.

If the one or more tokens satisfy the rule set at 2115, the one or more tokens become a candidate data artifact of the type 210 corresponding to the applied rule set, and syntax analyzer 1815 computes, at 2020, a probability ranking for the one or more tokens with respect to the applicable data-artifact type 210. If, on the other hand, the rule set is not satisfied at 2115, the one or more tokens are not deemed a candidate data artifact of the applicable type 210, and the process proceeds to Block 2025 without a probability ranking being computed.

In the illustrative embodiment of FIG. 20, determining, at 2010, whether the one or more tokens match the one or more predetermined patterns includes comparing at least one token among the one or more tokens with a database or list of known data values. As will be explained further below, the database or list of known values differs depending on the data-artifact type 210. In some embodiments, multiple databases or lists of known values are employed for a given data-artifact type 210. Comparing tokens with a database or list of known values helps to reduce both false-positive and false-negative classifications of data artifacts 215. The databases or lists of known data values can be compiled and maintained by infrastructure support system 110, as explained above.

If, at 2025, there are data-artifact types 210 for which the corresponding rule sets have not yet been applied to the sequence of tokens 1830, the process returns to Block 2005. Otherwise, the process terminates at 2030.

Another function that syntax analyzer 1815 performs is the assigning of local rankings to classified data artifacts 215. As explained above (refer to FIG. 1), search subsystem 125 handles the assignment of global rankings to data artifacts 215 retrieved as search results and presents the retrieved data artifacts 215 to the user in accordance with the global rankings.

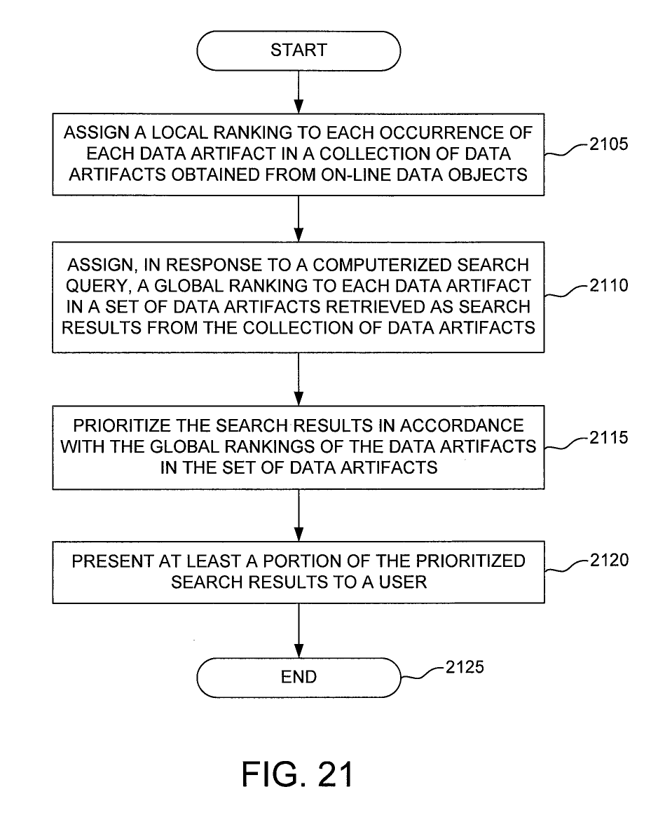

Before specific discovery and ranking rules for the various kinds of data artifacts 210 are discussed, an overview is provided of the local and global ranking aspects of system 100 in accordance with an illustrative embodiment of the invention. FIG. 21 is a flowchart of a method for prioritizing search results retrieved in response to a computerized search query in accordance with an illustrative embodiment of the invention. At 2105, syntax analyzer 1815 of ICI subsystem 1800 assigns a local ranking to each occurrence of each data artifact 215 in a collection of indexed and organized data artifacts 215 stored in storage subsystem 1865. In one illustrative embodiment, syntax analyzer 1815 assigns the local rankings during the data-artifact discovery and classification process described above. In this illustrative embodiment, the local ranking of a given data artifact 215 indicates its importance relative to other data artifacts 215 discovered in the same on-line data object.

At 2110, search subsystem 125 (see FIG. 1) assigns, in response to a computerized search query, a global ranking to each data artifact 215 in a set of data artifacts 215 retrieved as search results from the collection of data artifacts stored in storage subsystem 1865. At 2115, search subsystem 125 prioritizes the search results in accordance with their global rankings. At 2120, search subsystem 125 presents at least a portion of the prioritized search results to a user. The process terminates at 2125.

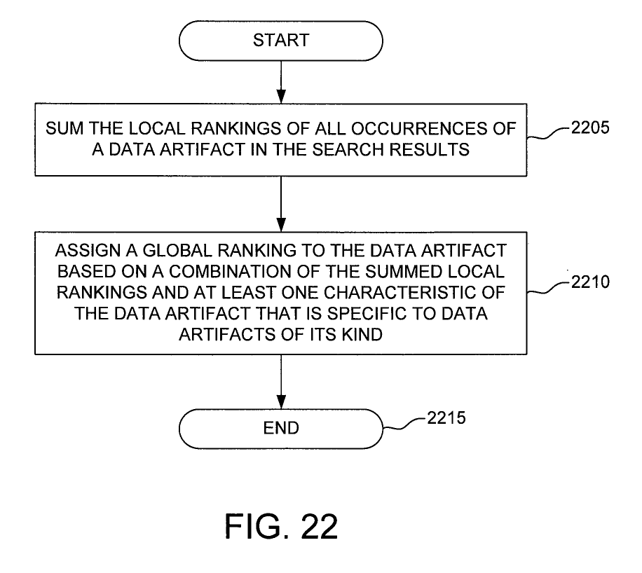

FIG. 22 is a flowchart of a method for assigning a global ranking to a data artifact in a set of data artifacts retrieved as search results from an indexed and organized collection of data artifacts in accordance with an illustrative embodiment of the invention. At 2205, search subsystem 125 sums the local rankings of all occurrences of a data artifact 215 in the set of data artifacts retrieved as search results. At 2210, search subsystem 125 assigns a global ranking to the data artifact 215 based on a combination of the summed local rankings and at least one characteristic of data artifact 215 that is specific to data artifacts 215 of its kind. Examples of such specific characteristics are discussed below in connection with illustrative global ranking rules that are applied to particular kinds of data artifacts 215. At 2215, the process terminates.

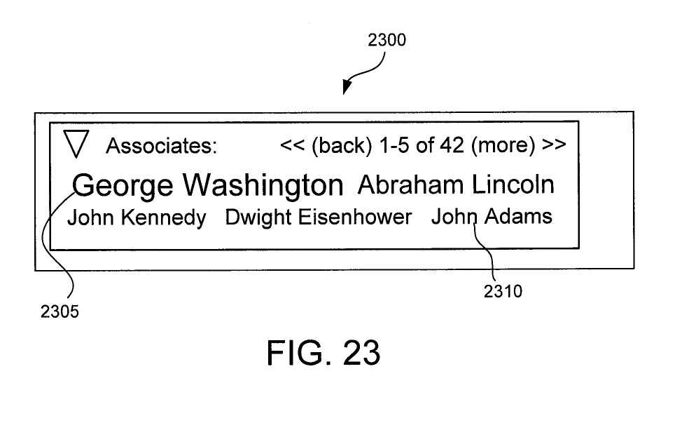

In presenting prioritized search results to a user, search subsystem 125 may optionally display data artifacts 215 in different font sizes and styles to indicate visually the relative global rankings of the displayed data artifacts 215. For example, search subsystem 125 can present data artifacts 215 having a higher global ranking in at least one of a more prominent font size and a more prominent font style than data artifacts 215 having a lower global ranking. This is illustrated in FIG. 23 in accordance with an illustrative embodiment of the invention. In associates pane 2300 of FIG. 23, associate data artifact “George Washington” 2305 is displayed in a larger font size than associate data artifact “John Adams” 2310 to indicate that the former has a higher global ranking than the latter.

The rule sets that syntax analyzer 1815 applies to the sequences of tokens are constructed in accordance with a formal grammar. The following is an illustrative rule grammar:
Rule sets are taken in the aggregate. All rule sets are executed as if all of the sets are combined into one large set of rules.
A rule set may consist of one or more rule elements.
Each rule element describes a particular portion of the rule set.
Each rule element is expressed as a single line of text.
Each rule element is composed of one or more rule components.
Rule components are separated by rule punctuators.
Rule punctuators are defined as follows:
   Single angle brackets are used to identify the name of an intermediate result of the scan. A typical result would be identified as <First Name>.
   Double angle brackets are used to delimit the name of a data artifact 215. If used, data-artifact names occur as the first component of an element. A typical data-artifact name would be identified as <<Affiliation>>.
   An equal sign identifies the assigning of a value to a named result. A typical assignment would appear as <First Name>=.
   A tilde identifies a rule assignment that is not to be executed in a first pass over the sequences of tokens. Thus, <<Clip>> identifies a data-artifact type 210 (“clipping”) that is discovered after the first pass.
   A colon and slash construction identifies a pair of empirically-derived numbers used in the probability ranking calculations. This probability ranking pair follows the applicable component. A colon separates the Probability Ranking pair from the preceding component. A typical component and its related probability ranking would be <<Subject Name>>:50/1. Handling of the rankings is discussed below.
   All string literals and regular expressions are enclosed in double quotation marks. The default handling of string literals is case sensitive. Thus, “Mr” is considered distinct from “mr”.
      If string literals are immediately preceded by an underscore character, handling of the literal is considered to be case insensitive. Thus, _“Mr” is considered the same as _“mr”.
   Table lookups are accomplished by appending a suffix to the component. Table lookup suffixes are of the form @TableName.
   Braces and pipe signs are used in combination to group and select from a choice of rule components. A typical selection would be identified as {rule1|rule2|rule3}, indicating a choice of any of the three rule components.
   Square brackets delimit optional choices. A typical option group would be identified as [A|B|C], indicating a choice of any one of the first three capital letters of the alphabet.
   Parentheses are used to group sequences of literals. A typical sequence would appear as “<Date> “1:” (<MM> <DD> <YY>)”.
   An exclamation point signifies that the preceding entry is to be added to the resulting output data artifact 215. For example, a sequence such as
      <First Name>![<Middle Initial>]<Last Name>!
   would indicate that a sequence requires a First Name, an optional Middle Initial, and a Last Name but that only the First Name and Last Name are to become part of the data artifact 215.
   A caret indicates that the following characters must occur at the beginning of a token.
   A dollar sign indicates that the preceding characters must occur at the ending of a token.
   A backward slash indicates that the following character is to be taken literally and is not to be considered as one of the rule punctuators. For example, the sequence “\˜” indicates the literal appearance of a tilde.
   A dash is used to separate a range of choices. For example, a sequence that appears as “A-Z” indicates any capital letter in the alphabet.
   An asterisk signifies that the previous component may appear any number of times, zero included. For example, a construct such as “[A-Z] [a-z]*” indicates a requirement for a single capitalized letter followed by any number of lower case letters.
   A question mark signifies that the preceding component should appear 0 or 1 time only. For example, a construction such as “[A-Z] ? ” indicates that a single capitalized letter must either be missing or appear only once.

Illustrative rules for detecting and ranking specific kinds of data artifacts 215 are described below. Those skilled in the art will recognize that a variety of alternative rules are possible for a given data-artifact type 210. In some embodiments, the performance of ICI subsystem 1800 is enhanced by implementing some or all of a rule set directly in software.

General Rules. Certain rule elements constitute the “ground rules” for subsequent rule applications. In effect, these rules are global rules that define certain basic components that may be used by many other rule sets. The following is an example of a general rule for identifying tokens in title case:

<Title Case>=“A [A-Z] [a-z]*$”.

That is, the first letter of the token is capitalized and subsequent letters are in lower case. Typical title-case tokens would appear as, for example, “George Washington.”

Rules for Names of People. As explained above, in some embodiments, system 100 is configured for on-line searching of information about people. In such an embodiment, a search subject or “subject name” is the name of a person about whom information is sought. Whether the search subject is the name of a person or some other kind of subject (e.g., a location), names of people can be discovered and classified as such through the application of a formal grammar such as the following:

```
<<Subject Name>>:88/1 = [<Name Prefix>:1/1]
    {(<First Name>!:80/1
    [{<First Name>:20/0|(<Initial>:2/0 [“.”]))}])|
    (<Title Case>:91/1 <Initial>:2/0 [“.”])} <Last Name>!
    [<Name Suffix:1/1]
<Name Prefix> = <Title Case>@PNAMES
<First Name> = <Title Case>@FNAMES
<Initial> = “\hat{ }[A–Z]$”
<Last Name> = <Title Case>@LNAMES
<Name Suffix> = <Title Case>@SNAMES
```

In this illustrative embodiment, the discovery rules for names of people may be interpreted as follows:
If present, a name prefix such as “Mr”, “Mrs”, etc., is recognized and discarded. In this particular embodiment, names of people are recognized without a name prefix. Those skilled in the art will recognize that there are many forms of address in addition to the prevalent “Mr.” and “Mrs.”
Next, a first name is recognized. A special case arises if the first name is accompanied by a middle initial. Middle initials are discarded in this illustrative embodiment.
Finally, a last name is recognized. A special case arises if the last name is accompanied by a name suffix such as “Jr”, “Sr”, etc. Name suffixes are also discarded.
The end result of the discovery, in an on-line data object, of a name-of-a-person data artifact 215 is a first name and a last name.

Recognition of names of people is complicated by the common occurrence of nicknames or alternate forms of names. For example, a name such as “Robert Smith” may appear as “Bob Smith.” Various morphological techniques can be employed to reduce a first name (e.g., “Bob”) to its base or “lemma” form. The lemma form is the canonical form of the first name after a morphological transformation has been performed. As a different example of a lemma form, consider that the dictionary word “go” is the lemma form of “go”, “goes”, “going”, “went”, and “gone”. Thereafter, variations on the name can be recognized based on the lemma form.

Since many Web pages and other on-line data objects include constructs in a title case format, capitalization alone is an insufficient basis for classifying a group of tokens as a person's name. In an illustrative embodiment, infrastructure support subsystem 110 maintains current lists of acceptable name parts such as name prefixes, first names, last names, and name suffixes (see, respectively, the PNAMES, FNAMES, LNAMES, and SNAMES tables referenced in the above rules). These lists of name parts support the name-discovery process. For example, the above name rule consults two tables built by infrastructure support subsystem 110 to ensure that a valid name is present. One test consults the FNAMES table to validate a potential first name; the other test consults the LNAMES table to validate a potential last name. If either test fails, the examined tokens are not recognized as a valid person's name.

In other embodiments, a unique (unrecognized) name part in combination with a common name part (e.g., “Plemayel Smith” or “John Sphluer”) is still recognized as a candidate name-of-a-person data artifact 215.

Local and global ranking of names-of-people data artifacts 215 are performed in accordance with the general description of local and global ranking above

Rules for Associates. In this illustrative embodiment, associate data artifacts 215 are not identified as such by ICI subsystem 1800 during the classification process. Instead, a data artifact 215 that has already been classified as a person's name is inferred to be an “associate” of a subject name—a different person's name that is the subject of a search query—based, at least in part, on proximity of the data artifact 215 to the subject name within an on-line data object. The inference yielding an associate data artifact 215 is drawn by search subsystem 125 during the processing of a search query, as explained above.

For example, suppose a Web page has the name Abraham Lincoln on it. In addition, the name George Washington is in close proximity to Lincoln's name. In even closer proximity to Washington's name, the Web page contains John Kennedy's name. In such a situation, a search for “John Kennedy” would result in the inference that both Washington and Lincoln are associates of Kennedy. Alternatively, a search for “Abraham Lincoln” would result in the inference that both Kennedy and Washington are associates of Lincoln.

Though, in this illustrative embodiment, there is no rule set for the discovery of associate data artifacts 215, syntax analyzer 1815 of ICI subsystem 1800 locally ranks names-of-people data artifacts 215, as explained above. In addition, there are specific global ranking rules for associate data artifacts 215. In one embodiment, the global ranking rules for associates are as follows:
1. If the associate and the subject name are contained within the same string, the global ranking for the associate is given by the following formula:

Local Rank=1/1{+(distance between the subject name and the associate)}.
2. If the associate and the subject name searched are in different strings but within the same on-line data object, the local ranking is computed in accordance with a different formula:

Local Rank=1/{1+[(distance between the subject name and the associate)*(number of strings on the page)]}.
3. In addition, a final test is applied to make sure a candidate associate is likely to be valid.: A candidate associate is discarded if the distance between the subject name and the candidate associate exceeds a predetermined limit. In one embodiment, the predetermined limit is 10 strings.

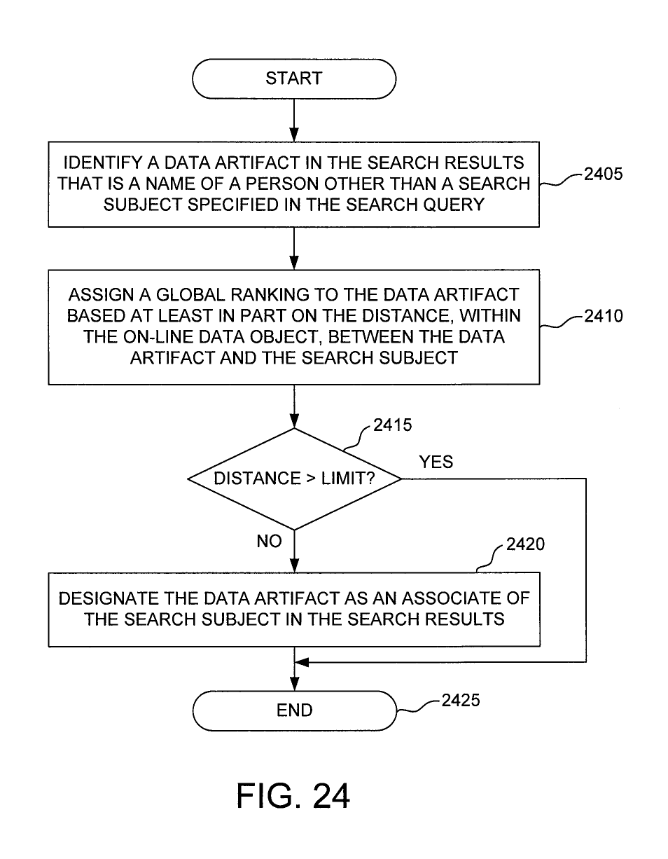

FIG. 24 is a flowchart of a method for assigning a global ranking to an associate data artifact 215 in accordance with an illustrative embodiment of the invention. At 2405, search subsystem 125 identifies, among the retrieved search results, a name-of-a-person data artifact 215 other than a subject name specified as a search subject in a search query. At 2410, search subsystem 125 assigns a global ranking to the name-of-a-person data artifact 215 based at least in part on the distance, within the on-line data object, between that data artifact 215 and the subject name. The above formulas are examples of how this can be done.

If the distance between the name-of-a-person data artifact 215 and the subject name exceeds a predetermined limit at 2415, the name-of-a-person data artifact 215 is disqualified as an associate data artifact 215. Otherwise, search subsystem 125, at 2420, designates the name-of-a-person data artifact 215 as an associate data artifact 215 of the subject name in the search results. At 2425, the process terminates.

Rules for Locations. A location data artifact 215 may represent a country, a U.S. state or state code, a partial name of a U.S. state, a province, a city, a partial name of a city, a place name, or other indicator of geographic location. In an illustrative embodiment, the formal grammar for the detection and classification of a location is as follows:

```
<<Location>> = ( <City> <State> | <City> “,” <State> |
    <City> “(” <State> “)” )
<City> = @CTY1! | ( @CTY2_1! @CTY2_2! ) | ( @CTY3_1!
    @CTY3_2! @CTY3_3! ) | @CTY2A_1! “-”!
    @CTY2A_2! ) |
    ( ( “St”! “.” | “Saint”! ) @STCTY! )
    | ( ( “Ft”! “.” | “Fort”! ) @FTCTY! )
<State> = @ST1! | ( “New”! ( “Hampshire”! | “Jersey”! | “Mexico”!
    | “York”! ) ) | ( “North”! ( “Carolina”! | “Dakota”! ) ) |
    ( “No”! “Dak”! )
    | ( “Rhode”! “Island”! ) | ( “South”!
    ( “Carolina”! | “Dakota”! ) ) | ( “West”! Virginia”! ) |
    ( “District”! _“of”! “Columbia”! )
```

Recognition of cities and states is complicated by the observation that many people's names overlap the names of cities and states. For example, consider a movie actress named Dakota Fanning. To optimize the discovery of locations, ICI subsystem 1800 classifies as location data artifacts 215 only a narrow range of possible combinations of tokens. For a potential location classification, syntax analyzer 1815, in this illustrative embodiment, requires that a combination of tokens appear in a specific arrangement such as “city, state” or another well-defined pattern. By carefully restricting the possible geographic location formats, cases such as “George, Washington” can be recognized as locations, not names of people.

Syntax Analyzer 1815 also uses a set of tables containing known geographic locations to validate one or more tokens as representing a location. By carefully restricting what qualifies as a location, the overall discovery accuracy of ICI subsystem 1800 is enhanced. In the illustrative location rule set above, tables CTYx and STx contain, respectively, city names and common abbreviations and postal abbreviations for U.S. states. Through use of these tables of known values, a pair of tokens such as “Los Denver,” for example, will not be recognized as a valid city, but “Los Angeles” will be. Syntax analyzer 1815 can also be configured, via the CTY2A_1 and CTY2A_2 tables in the above rule set, to handle hyphenated location names such as Raleigh-Durham.

In general, the tables of known geographic locations can include one or more of countries, U.S. states or state abbreviations, partial names of U.S. states, provinces, cities, partial names cities, place names, or any other indicator of geographic location. Such tables of known geographic locations can be compiled and maintained by infrastructure support subsystem 110.

Local and global ranking of location data artifacts 215 are performed in accordance with the general description of local and global ranking above.

Rules for Affiliations. Affiliation data artifacts 215 indicate membership or interest in corporations, clubs, groups, political parties, churches, or other organizations. In an illustrative embodiment, the formal grammar for the detection and classification of an affiliation data artifact 215 is as follows:

```
<<Affiliation>>:95/1 = <Title Case>!:91/1 [<Title Case>!:1/0
    [<Title Case>!:1/0 [<Title Case>!:1/0
    [<Title Case>!:1/0]]]] <Corp Suffix>!
<Corp Suffix> = @CNAMES:200/1
```

Syntax analyzer 1815 can be configured to recognize many kinds of affiliation descriptions in addition to the prevalent “Corporation,” “Ltd.,” etc. It is advantageous for infrastructure support subsystem 110 to maintain current lists of known organization root names (e.g., “International Business Machines”) and suffixes (e.g., “Inc.”) to support the affiliation discovery process. For example, in the illustrative rule set above, such support is provided by the CNAMES table. In generating the tables of known organization root names and suffixes, infrastructure support subsystem 110 can be configured to adhere to standard uppercase and lowercase conventions for corporate suffixes.

Syntax analyzer 1815 can infer an affiliation between a name of a person and a data artifact 215 classified as a name of an organization based, at least in part, on proximity, within an on-line data object, of the data artifact 215 classified as a name of an organization to the person's name. This inference allows ICI subsystem 1800 to associate the affiliation data artifact 215 with a subject in storage subsystem 1865.

Local and global ranking of affiliation data artifacts 215 are performed in accordance with the general description of local and global ranking above.

Rules for Text-Block Data Artifacts. Some data artifacts 215 constitute extended blocks of information relating to a subject. Such data artifacts 215 are herein broadly termed “text-block data artifacts.” Examples of text-block data artifacts 215 include, without limitation, clippings, educational items, and biographies. Unlike many other data artifacts 215, text-block data artifacts 215 may extend over a significant portion of an on-line data object. Syntax analyzer 1815 treats text-block data artifacts 215 more as unstructured blocks of text than as tightly structured data artifacts 215.

Syntax analyzer 1815, in a pass over the token sequences 1830 subsequent to the first pass, applies a rule set tailored to the particular kind of text-block data artifact 215 to determine whether a sequence of tokens 1830 or a portion thereof matches one or more characteristic text-block patterns defined by the applicable rule grammar. If so, syntax analyzer 1815 classifies the tokens as a text-block data artifact 215 and associates the text-block data artifact 215 with a subject found within the on-line data object in which the text-block data artifact 215 was found. As discussed above, the search subject may be a name of a person or another kind of subject.

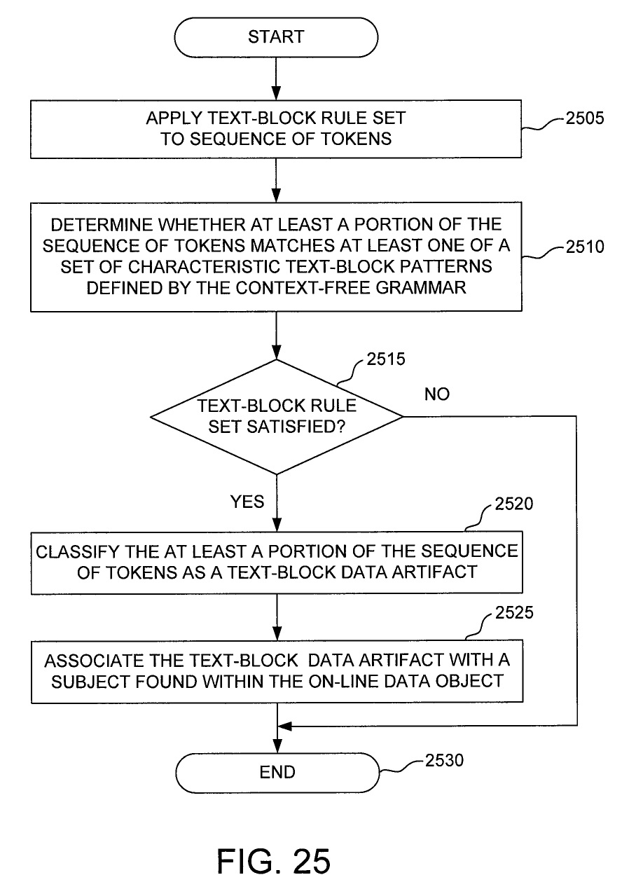

FIG. 25 is a flowchart of a method for applying a text-block rule set to a sequence of tokens 1830 in accordance with an illustrative embodiment of the invention. At 2505, syntax analyzer 1815, during a data analysis phase subsequent to a first data analysis phase, applies a text-block rule set to a sequence of tokens 1830. At 2510, syntax analyzer 1815 determines whether at least a portion of the sequence of tokens 1830 matches at least one of a set of characteristic text-block patterns defined by the context-free grammar of the text-block rule set. If the text-block rule set is satisfied at 2515, syntax analyzer 1815 classifies the sequence of tokens or the applicable portion thereof as a text-block data artifact 215 at 2520. At 2525, syntax analyzer 1815 associates the text-block data artifact 215 with a subject found within the same on-line data object. At 2530, the process terminates.

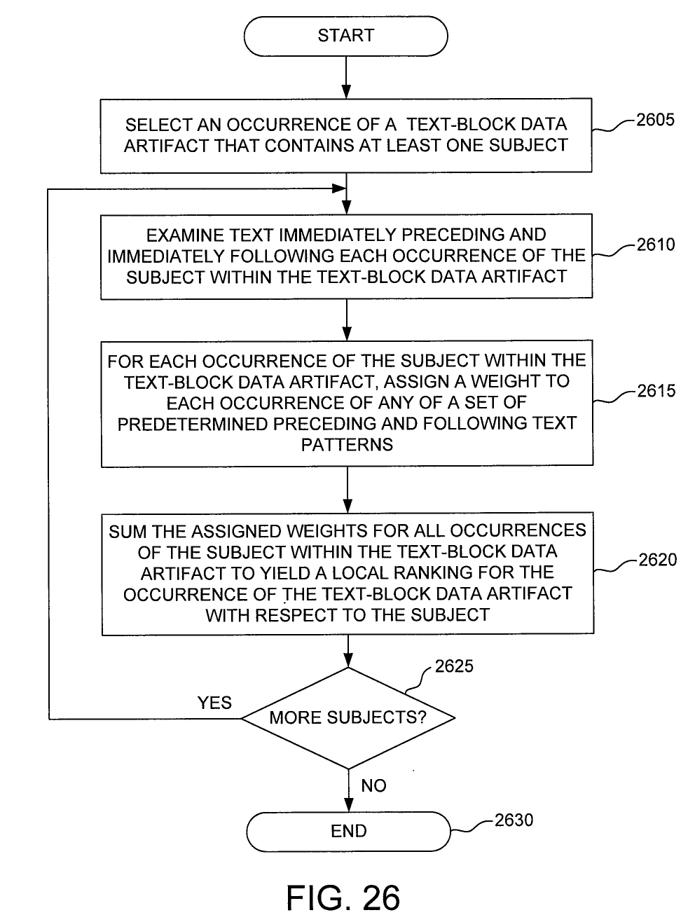

FIG. 26 is a flowchart of a method for assigning a local ranking to an occurrence of a text-block data artifact in accordance with an illustrative embodiment of the invention. At 2605, syntax analyzer 1815 selects an occurrence of a text-block data artifact that contains at least one subject. At 2610, syntax analyzer 1815 examines the text immediately preceding and immediately following each occurrence of the subject within the text-block data artifact 215.

For each occurrence of the subject within the text-block data artifact 215, syntax analyzer 1815 assigns, at 2615, a weight to each occurrence of any of a set of predetermined preceding and following text patterns. At 2620, syntax analyzer sums the assigned weights for all occurrences of the subject within the text-block data artifact 215 to yield the local ranking, with respect to the subject, of the particular occurrence of the text-block data artifact 215.

If there are additional subjects contained within the text-block data artifact at 2625, Blocks 2610 through 2620 are repeated for each remaining subject. Otherwise, the process terminates at 2630.

Illustrative rule sets for specific types of text-block data artifacts 215—clippings, educational items, and biographies—are discussed below.

Rules for Clippings. In an illustrative embodiment, the formal grammar for the detection and classification of a clipping data artifact 215 is as follows:

```
[<<Clip>>:1/5] ~ [<Clip SN Prefix>]
    <<Subject Name>>:0/0 [“,”:0/1] [<Clip SN Suffix>]
<Clip SN Prefix> = _“said”:200/1 | _“by”:200/1 |
    _“contact”:100/1
<Clip SN Suffix> = _“is”:1000/1 | _“was”:500/1 |
    _“said”:300/1 | _“has”:0/1 | _“to”:0/1 |
    _“\hat{ }.*ed$”:0/1 | _“\hat{ }.*s$”:0/1
```

Local ranking of clippings follows the outline discussed above in connection with FIG. 26. By definition, a clipping contains at least one subject name. For every subject name in the clipping, syntax analyzer 1815 inspects the text surrounding the subject name and computes a local ranking as follows:
For certain preceding text patterns that immediately precede the subject name, syntax analyzer 1815 assigns a weight. For example, a phrase such as “ . . . said John Kennedy . . . ” will be assigned a certain weight by syntax analyzer 1815.
For certain following text patterns that immediately follow the subject name, syntax analyzer 1815 assigns a weight. For example, a phrase such as “ . . . . John Kennedy said . . . ” will be assigned a certain rank value by syntax analyzer 1815.
For each occurrence of a subject name, syntax analyzer 1815 sums the weights for that subject name to yield the local ranking of the clipping data artifact 215 with respect to that subject name. Syntax analyzer 1815 can be configured to account for multiple subject names contained within a single clipping.

Rules for Education. As discussed above, education data artifacts 215 are clipping-like blocks of information regarding a subject name's educational attainments. As with clippings, it is possible for an education data artifact 215 to contain other data artifacts 215 within it.

The discovery rules for education data artifacts 215 are analogous to those for clippings, the primary difference being that the predetermined preceding and following text patterns for education data artifacts 215 are designed to identify references to the educational attainments associated with a subject name. Examples of preceding text patterns are “ . . . a B.S. degree was awarded to . . . ” and “ . . . upon graduating from . . . ”. Examples of following text patterns are “ . . . received her M.S. degree . . . ” and “ . . . graduated magna cum laude from . . . ”.

Local and global ranking of education data artifacts 215 can also be performed in a manner similar to clippings.

Rules for Biographies. A biography data artifact 215, another kind of text-block data artifact 215, contains biographical information about a subject.

The discovery rules for biographies are analogous to those for clippings but are tailored to the particular characteristics of biographical information. For example, preceding text patterns that might occur in a biography data artifact 215 include “bio” and “biography of . . . ”. Such preceding text patterns might not immediately precede the subject name in all cases, and the rule set can take that into account. Examples of following text patterns for biographies include “ . . . was born in . . . ” and “ . . . grew up in . . . ”.

Local and global ranking of biography data artifacts 215 can also be performed in a manner similar to clippings and other text-block data artifacts 215.

Rules for Tags. Tags represent meaningful information that does not fit within the data-artifact types 210 that are identified on the first pass over the sequences of tokens 1830. In an illustrative embodiment, the formal grammar for the detection and classification of tag data artifacts 215 is as follows:

```
{<<Tag>>} ~ ( [<Terminal>] <Word Form>! <Word Form>!
    [<Word Form>! [<Word Form>! [<Word Form>!]]]
    [<Terminal>] ) | <Single Word Tag>!
<Terminal> = <<Subject Name>> | <<Affiliation>> |
    <Punctuator> | <Terminal Word>
<Word Form> = [<Preposition>!] [<Article>] <Word>!
<Single Word Tag> = @SWTAGS
<Punctuator> = “!” | “\”” | “#” | “\$” | “%” | “&” | “\’” |
    “\(” | “\)” | “\*” | “\+” | “,” | “−” | “\.” | “/” |
    “:” | “;” | “<” | “=” | “>” | “\?” | “@” | “\[” |
    “\\” | “\]” | “\\hat{ }” | “_” | “\‘” | “\{” | “\|” | “\}” |
    “\~”
<Terminal Word> = <Conjunction> | <Auxiliary Verb> |
    <Pronoun>
<Preposition> = _@PREPS
<Article> = _“the” | _“a” | _“an”
<Word> = “\hat{ }[A–Za–z\’\−0–9]+$”
<Conjunction> = _@CONJS
<Auxiliary Verb> = _@XVERBS
<Pronoun> = _@PRONOUNS
```

SWTAGS, a list built by infrastructure support subsystem 110, contains an extensive list of acceptable tag words with which the tokens in a sequence of tokens 1830 are compared. In some embodiments, one-word tags are permitted; in other embodiments, they are disallowed. PREPS, another list built by infrastructure support subsystem 110, contains a list of prepositions that have been determined to be acceptable marker words that presage a tag data artifact 215.

CONJS and XVERBS are lists that are used together to detect certain combinations of “joining” words and particular verbs following. If such combinations are detected, they are considered an acceptable trailing marker indicating a tag. A typical example of such a marker is: “ . . . and has . . . ”. Those skilled in the art will recognize the many possible combinations of the CONJS and XVERBS lists.

PRONOUNS is a list of common pronouns, that, depending on the particular embodiment, may include, without limitation, one or more of the following types of pronouns: subjective and objective personal pronouns, possessive personal pronouns, demonstrative pronouns, interrogative pronouns, relative pronouns, indefinite pronouns, reflexive pronouns, and intensive pronouns. Those skilled in the art will recognize that a wide variety of pronouns may be included in the PRONOUNS list.

The classification of tags data artifacts 215 can be improved by analyzing a set of tokens identified as a potential tag data artifact (e.g., a set of tokens that satisfies the above tags rule set) for the density of certain “key tokens” within the potential tag data artifact. In this illustrative embodiment, a “key token” is defined as (1) any word made up entirely of lowercase characters that is found in a list of known key tokens or (2) any word containing one or more uppercase characters. In other embodiments, a “key token” may be defined differently as needed to alter the number and kinds of tag data artifacts 215 that are produced. The foregoing definition is merely one example that has been found to produce satisfactory results.

In one illustrative embodiment, the number of key tokens in the potential tag data artifact is counted. The key-token-density of the potential tag data artifact is then calculated as the ratio of the number of key tokens in the potential tag data artifact to the total number of words in the potential tag data artifact, excluding prepositions. Other methods of calculating the key-token density of the potential tag data artifact may be employed in other embodiments. In one embodiment, a potential tag data artifact is considered a valid tag data artifact 215 and is classified as such only if the key-token density of the potential tag data artifact is 50 percent or more. In other embodiments, a threshold lower or higher than 50 percent may be used. Key-token-density analysis is optional and may be omitted in some embodiments.

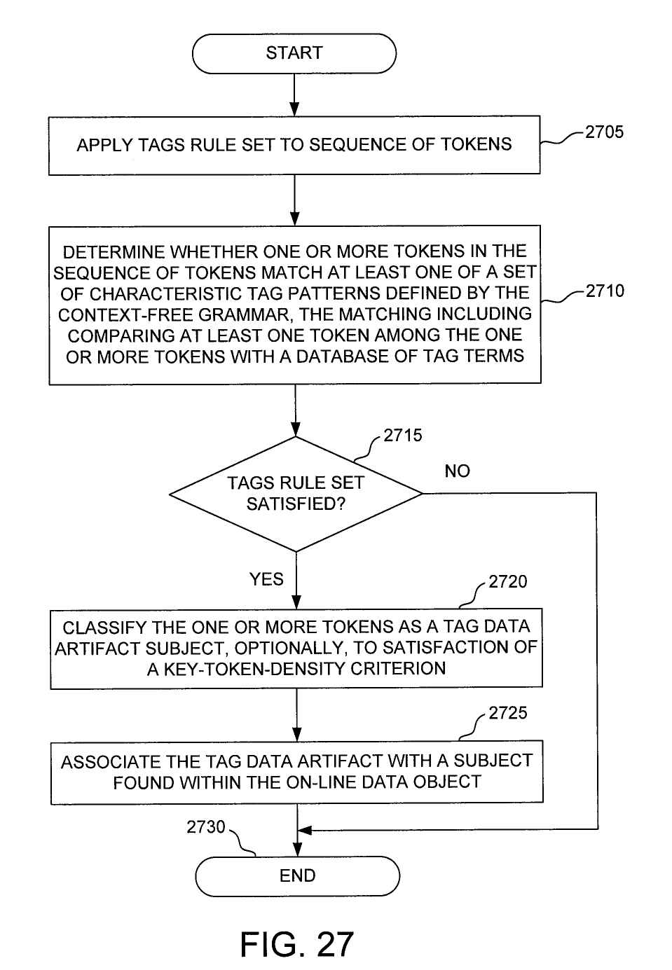

FIG. 27 is a flowchart of a method for applying a tags rule set to a sequence of tokens in accordance with an illustrative embodiment of the invention. At 2705, syntax analyzer 1815, during a second analysis phase subsequent to a first analysis phase, applies a tags rule set to a sequence of tokens. At 2710, syntax analyzer 1815 determines whether one or more tokens in the sequence of tokens matches at least one of a set of characteristic tag patterns defined by the context-free grammar of the tags rule set. In the embodiment of FIG. 27, syntax analyzer 1815, in making this determination, compares at least one token among the one or more tokens with a predetermined database or list of tag terms, as explained above.

If the one or more tokens in the sequence of tokens satisfy the tags rule set at 2715, syntax analyzer 1815 classifies the one or more tokens as a tag data artifact 215 at 2720. As discussed above and as indicated in FIG. 27, classification of a set of tokens satisfying the tags rule set as a tag data artifact 215 at 2720 may optionally be contingent upon the set of tokens satisfying a key-token-density criterion, depending on the particular embodiment. At 2725, syntax analyzer 1815 associates the classified tag data artifact 215 with a subject found within the same on-line data object. At 2730, the process terminates.

Local and global ranking of tag data artifacts 215 are performed in accordance with the general description of local and global ranking above.

Rules for URLs. As discussed above, search subsystem 125 can provide to a user a list of Web-page addresses (URLs) pointing to the Web pages from which the retrieved search results were obtained. To support this capability, ICI subsystem 120 carefully records each Web page URL during the data-artifact discovery and classification process. In some embodiments, system 100 records and presents to the user the addresses associated with other kinds of on-line data objects from which the search results were obtained.

Since URL data artifacts 215 are extrinsic to the Web pages to which they correspond, they are not assigned local rankings. In an illustrative embodiment, however, each URL data artifact 215 is assigned a global ranking. In this particular embodiment, it is assumed that the search subject is a subject name (a person's name). However, the principles that the following global-ranking approach illustrates can be applied to other kinds of subjects besides names of people. In this illustrative embodiment, the global ranking of URLs is performed as follows:
The URL of the Web page being processed is selected.
The URL is searched for a substring that matches the last name of the subject name. (Note: In this context, “string” and “substring” have their ordinary meanings in the computing art—a group of contiguous characters.)
   If the last name is found as a string or substring of the URL, the rank is initialized to a low value. If no substring is found corresponding to the last name, the rank is initialized to zero.
   The farther right that a substring is found within the URL, the lower the assigned rank. For example, a last name of “Kennedy” would have a certain rank when found in “kennedy.com” and would have a lower rank when found in “webpage.com/kennedy/”.
If the first name of the subject name is found as a string or substring of the URL, a medium value is added to the existing rank. If no substring is found for the first name, the rank remains unchanged.
   The farther right that a substring is found within the URL, the lower the assigned rank. For example, a first name of “John” would have a certain when found in “johnkennedy.com” and would have a lower rank when found in “webpage.com/johnkennedy/”.
If both the first name and the last name (in the proper relationship to each other) are found as strings or substrings of the URL, a high value is added to the existing rank. If no substring is found for the first name/last name combination, the current rank remains unchanged.
   The farther right that a substring is found in the URL, the lower the assigned rank. For example, a first/last name of “John Kennedy” would have a certain rank when found in “johnkennedy.com” and would have a lower rank when found in “webpage.com/johnkennedy/”.
   Search subsystem 125 can be configured to deal with punctuation and white space in analyzing first name/last name combinations. For example, search subsystem 125 can be configured to treat the substring “johnkennedy” the same as the substring “john_kennedy”.

The global ranking of a URL data artifact 215 is obtained by combining the above partial ranking with the local rankings of all non-URL data artifacts 215 discovered on the Web page to which the URL data artifact 215 corresponds. Thus, search subsystem 125 assigns a higher global ranking to URLs corresponding to Web pages that contain more data artifacts 215 than to URLs corresponding to Web pages that contain fewer data artifacts 215.

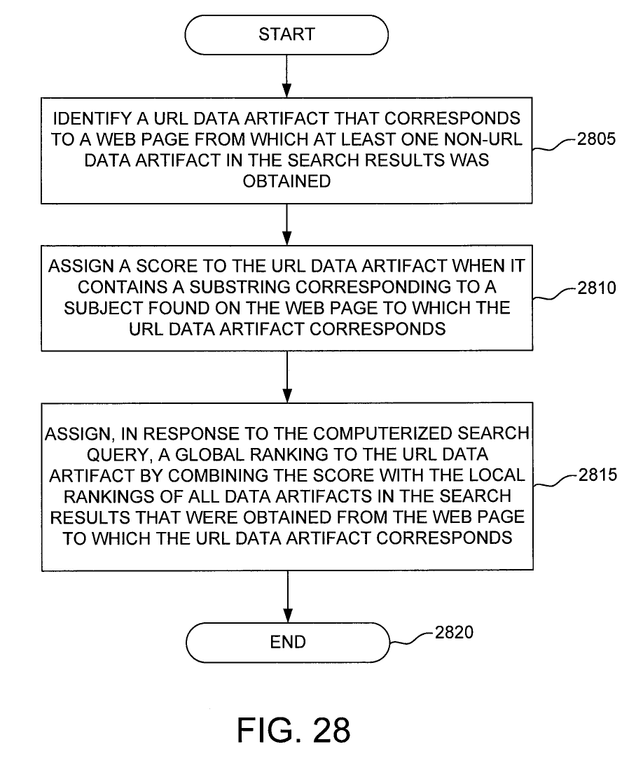

FIG. 28 is a flowchart of a method for assigning a global ranking to a URL data artifact 215 in accordance with an illustrative embodiment of the invention. At 2805, search subsystem 125 identifies a URL data artifact 215 among the retrieved search results that corresponds to a Web page from which at least one non-URL data artifact 215 in the search results was obtained. At 2810, search subsystem 125 assigns a score to the URL data artifact 215 if it contains a substring corresponding to a search subject found on the Web page to which the URL data artifact 215 corresponds.

At 2815, search subsystem 125 assigns, in response to a computerized search query, a global ranking to the URL data artifact 215 by combining the score with the local rankings of all data artifacts in the search results that were obtained from the Web page to which the URL data artifact 215 corresponds. At 2820, the process terminates.

Rules for Other Types of Data Artifacts. Discovery and local and global ranking rules for other types of data artifacts 215 such as identifiers and hobbies/interests can also be included in system 100.

In some embodiments, system 100 is configured to identify as data artifacts 215 images found in on-line data objects and to rank and display image data artifacts 215 with other retrieved search results in response to a search query. In these embodiments, ICI 1800 preserves references to images (e.g., URLs associated with HTML “img” tags on Web pages). Since the image references are preserved, there is no need to store the actual image data in storage subsystem 1865. Instead, when search subsystem 125 presents search results to a user, search subsystem 125 accesses the source on-line data objects in which the images are found in accordance with the references stored in storage subsystem 1865 and displays the highest-ranked image data artifacts 215 for the indicated subject. Those skilled in the art will recognize that, where storage space is abundant, the actual image data can be stored in storage subsystem 1865 in a different embodiment.

In some embodiments, syntax analyzer 1815 is configured to screen images to determine whether they are of potential interest. For example, syntax analyzer 1815, in some embodiments, analyzes images to determine whether they are likely to depict a particular category of subject (e.g., a person). Such screening could include examining an image's size and aspect ratio, applying a min/max filter or other digital filter to the image, or applying pattern recognition techniques to the image.

As with other types of data artifacts 215, syntax analyzer 1815 attempts, during data-artifact discovery and classification, to associate each image data artifact 215 with a subject. A variety of techniques may be employed in making this association. In some embodiments, syntax analyzer 1815 parses the image file name contained within the image reference to determine whether the file name contains a text pattern associated with a subject found elsewhere within the same on-line data object in which the image was found. As explained above, a subject, in some embodiments, is a person's name; in other embodiments, a subject corresponds to a different kind of data artifact 215. In the context of a people-search embodiment, an image file name might contain a first name, a last name, or both.

In general, as with other types of data artifacts 215, ICI 1800 can be configured to use an image reference's style, location within an on-line data object, proximity to a subject, or other metadata in defining the relatedness of the associated image to a subject. Such relatedness information can be used in assigning local and global rankings to image data artifacts 215, as explained above.

Probability Ranking. As mentioned above, probability ranking involves an assessment of the likelihood that a given set of tokens belongs to a particular class of data artifacts 215. Probability ranking should not be confused with local ranking or global ranking, which are discussed separately above.

Consider probability ranking for a typical data-artifact type 210, affiliates:

```
<<Affiliation>>:95/1 = <Title Case>!:91/1 [<Title Case>!:1/0
    [<Title Case>!:1/0 [ <Title Case>!:1/0
    [<Title Case>!:1/0]]]] <Corp Suffix>!
<Corp Suffix> = @CNAMES:200/1
```

Probability ranking considers the “:XX/YY” constructions within the rules, where XX and YY represent positive integers of up to two digits. The numbers XX and YY, which are empirically derived, act as control parameters for the probability-ranking process. First, syntax analyzer 1815 sums all of the XX portions of the construction for which a matching token has been detected. In this illustrative embodiment, the last token discovered for a given rule set is not included in the summation. The sum of the XX portions is referred to as SUM(XX). If SUM(XX) is zero, it is reset to 1. The YY portions are summed and, if necessary, corrected to unity in the same fashion to yield SUM(YY).

Next, the probability ranking is computed according to the following formula:

Probability Ranking=(SUM(XX)*Last token XX*Scale Factor)/(SUM(YY)* (Last token YY)).

In the case of the above example and depending on how many tokens were selected for application of the affiliates rule set, the probability ranking might appear similar to the following:

((95+1+1)/(1+0+0))*200*100=1,940,000.

Those skilled in the art will recognize that considerable adjustment of the probability ranking parameters might be needed as on-line data sources such as the Web evolve over time. This is a normal part of the evolution of system 100.

Syntax analyzer 1815 applies the above probability ranking techniques to each rule set as a set of potential data-artifact tokens are being considered. Once a probability ranking has been computed for each data-artifact type 210 for which the set of tokens is a candidate, the highest-ranking data-artifact type 210 is selected as the classification for that set of tokens. In other words, syntax analyzer 1815, in this illustrative embodiment, considers all possible data-artifact types 210 for a given set of tokens under examination before selecting a final data-artifact type 210 to assign to the set of tokens.

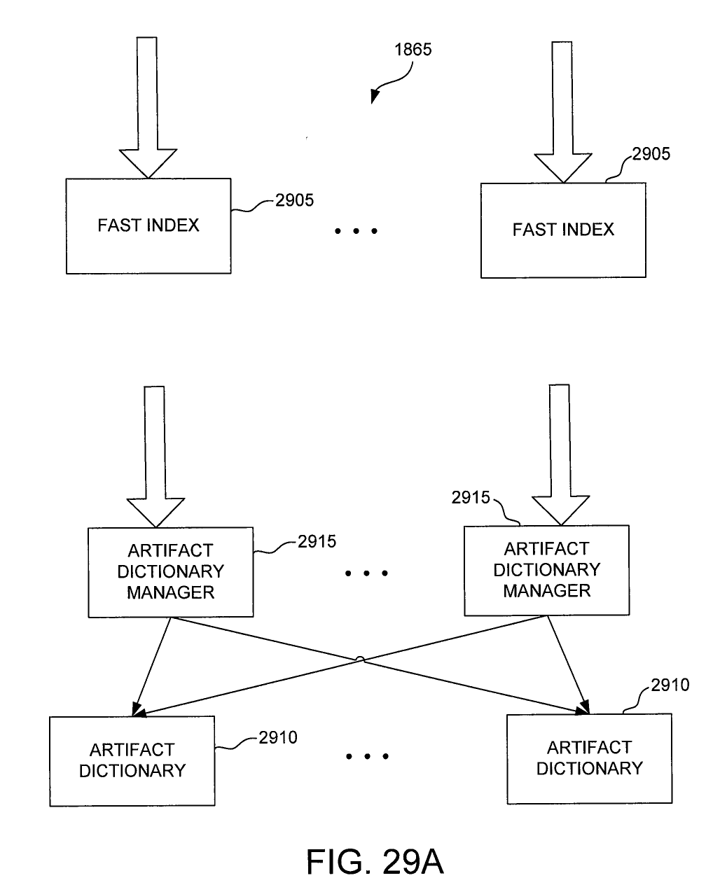

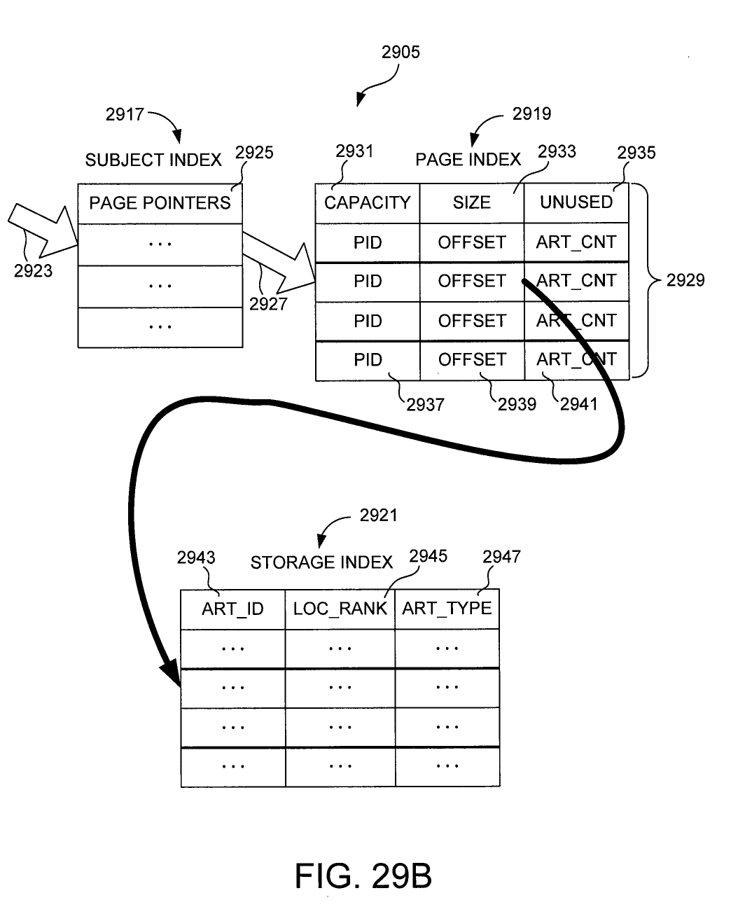

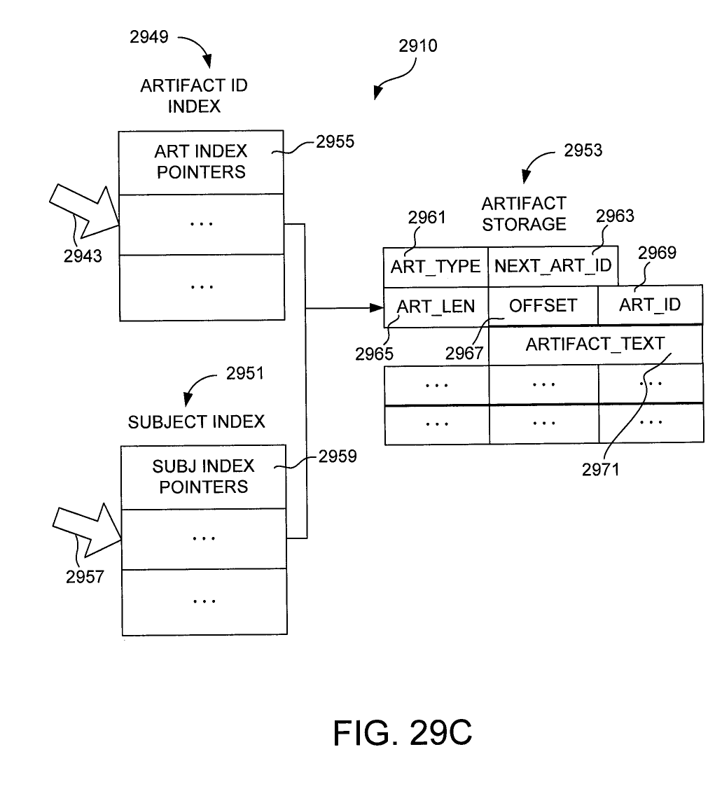

FIG. 29A is a functional block diagram of storage subsystem 1865 (see FIG. 18) in accordance with an illustrative embodiment of the invention. Storage subsystem 1865 includes three primary functional components: fast index 2905, artifact dictionary 2910, and artifact dictionary manager 2915. As indicated in FIG. 29A, each of these components can be replicated and distributed across multiple servers in some implementations to enable parallel processing of incoming Web pages in a rapid and efficient manner. This is consistent with embodiments in which the entire data-artifact discovery and collection process carried out by ICI subsystem 1800 is distributed over multiple servers.

For each data artifact 215 identified by syntax analyzer 1815, fast index 2905 stores the relevant data. Data artifacts 215 are added to fast index 2905 incrementally. That is, each newly detected data artifact 215 is added to the appropriate area of fast index 2905. Fast index 2905 records the occurrence of each detected data artifact 215, but it does not store the data artifacts 215 themselves. Instead, in connection with each occurrence of a given data artifact 215, fast index 2905 stores a pointer to that data artifact 215, which is stored non-redundantly in artifact dictionary 210. That is, if a particular data artifact 215 appears more than once among the on-line data objects analyzed, a reference to each specific occurrence of that specific data artifact 215 is recorded in the proper place in fast index 2905, and the references points to the actual data artifact 215 in artifact dictionary 210. In this manner, it is possible to store references to the occurrences of all detected data artifacts 215 found in various on-line data objects, including all Web pages throughout the entire World Wide Web.

Fast index 2905 records data-artifact occurrence details on a data-object-by-data-object basis. In the case of Web pages, for example, data-artifact occurrence details are recorded on a page-by-page basis. All of the data-artifact occurrences detected in a given on-line data object are grouped and recorded together in a specific portion of fast index 2905. In addition, all of a particular on-line data object's data artifacts 215 are organized by subject at a higher level. In this illustrative embodiment, fast index 2905 is hierarchically organized as follows:
Top Level—Index to subjects in artifact dictionary 2910
   Second Level—All on-line data associated with a particular subject
      Detail Level—Pointers to artifact dictionary 2910 for all data-artifact occurrences found in a given on-line data object.

### Storing data artifacts 215 in this manner enables search subsystem 125 to retrieve all basic search results for a given subject in a single access of storage subsystem 1865, if desired.

Those skilled in the art will recognize that a particular on-line data object may contain more than one subject. This is a common situation that requires fast index 2905 to maintain essentially duplicate entries. For example, in an embodiment configured for people search, if both “George Washington” and “Thomas Jefferson” appear as subject names on the same Web page, fast index 2905 will maintain two essentially identical storage blocks for the Web page that contains the two subject names. This illustrates the classical tradeoff between processing speed and storage efficiency. In this illustrative embodiment, system 100 is configured for speed at the expense of additional storage to provide rapid responses to search queries.

FIG. 29B is a diagram of fast index 2905 in accordance with an illustrative embodiment of the invention. Fast index 2905 is divided into three functional elements: subject index 2917, page index 2919, and storage index 2921. Fast index 2905 is configured to perform four types of processing functions:
1. Create a new entry for a new on-line data object and all of its data artifacts 215;
2. Replace an entry for an existing on-line data object with a new/revised set of data artifacts 215;
3. Delete an entry for an on-line data object and all of its data artifacts 215; and
4. Search for an entry corresponding to a selected on-line data object and recover its data artifacts 215.

Access to fast index 2905 begins with an artifact index 2923 corresponding to a selected subject. In one illustrative embodiment, artifact index 2923 is obtained from artifact dictionary 2910 and is explained in further detail below. Artifact index 2923 is used to obtain a slot or row of information in subject index 2917. The selected row of subject index 2917 contains page pointer 2925. In turn, page pointer 2925 is used as an index 2927 to access an information block 2929 in page index 2919 that is associated with the selected subject.

The accessed information block 2929 in page index 2919 is a single logical block of data associated with the subject to which artifact index 2923 corresponds. The first row of information block 2929 contains control elements regarding the entire information block 2929, and the subsequent rows contain further data-artifact information.

The first row of information block 2929 contains a count of the maximum number of elements in the block (capacity 2931); a count of the number of elements contained in the information block 2929 (size 2933); and a count of the number of unused data elements in information block 2929 (unused 2935). By allocating a suitable amount of space in advance, efficient access to information block 2929 can be provided without the necessity of less efficient threaded lists of blocks. Storage subsystem 1865 includes mechanisms to ensure that block allocation provides for efficient lookup and that overflows are handled correctly.

The rows of information block 2929 subsequent to the first row are devoted to the storage and organization, for the indicated subject, of references to the data artifacts 215 obtained from the various on-line data objects analyzed by ICI subsystem 1800. For every on-line data object (e.g., Web page) containing the indicated subject, a row is created in the corresponding information block 2929.

Each row of information block 2929 subsequent to the first row contains a page ID (PID) 2937; an offset 2939; and an artifact count 2941. PID 2937 is an index that points back to artifact dictionary 2910 mentioned above. Offset 2939 is an index used to access storage index 2921, in which all data-artifact-occurrence information associated with the selected subject and obtained from the applicable on-line data object may be found. Artifact count 2941 is the number of data-artifact occurrences from the associated on-line data object that are stored in storage index 2921 for the selected subject.

Access to the data artifacts 215 for a given on-line data object begins with the data blocks stored in storage index 2921. The data artifacts 215 from a given on-line data object and associated with the selected subject can be stored as a contiguous set of rows that is accessed via offset 2939 in page index 2919.

The first data component of each row of storage index 2921 is artifact ID 2943, which points back to artifact dictionary 2910. The next data component is the local ranking 2945 of the data artifact 215 with respect to the applicable subject and on-line data object. Local ranking 2945 is used during searches to help establish a global ranking of the data artifact 215, as discussed above. The final data component in each row is an artifact type (ART_TYPE) 2947, a code representing the type of data artifact 215 referenced by this row. Artifact type 2947 can be used during searches to help quickly arrange data artifacts 215 and to support global ranking.

Each instance of artifact dictionary 2910 stores data artifacts 215 and related information. In contrast with fast index 2905, which stores the occurrence data for a given data artifact 215, artifact dictionary 2910 stores the actual content of the data artifact 215 (e.g., the name “Bob Smith” for a name-of-a-person data artifact 215). Each data artifact 215 of a particular type 210 is stored only once in artifact dictionary 2910. Thus, fast index 2905 stores the details of each and every occurrence of a name-of-a-person data artifact 215 such as “George Washington,” whereas artifact dictionary 2910 records “George Washington” only once. The details of the storage format depend on the particular type of data artifact 215. For example, a clipping data artifact 215 might be stored as a text string of arbitrary length.

The management and routing of requests to each artifact dictionary process/server 2910 is managed by an artifact dictionary managers 2915, which can also be instantiated across multiple servers. Each artifact dictionary manager 2915 is fully capable of receiving data-artifact storage access requests and dispatching the request to any of the artifact-dictionary instantiations. Employing multiple instances of artifact dictionary manager 2915 enhances processing speed and provides redundancy against component failure.

FIG. 29C is a diagram of artifact dictionary 2910 in accordance with an illustrative embodiment of the invention. Artifact dictionary 2910 is divided into three functional components: artifact ID index 2949, subject index 2951, and artifact storage table 2953.

Artifact ID index 2949 provides access to the various data-artifact values stored in artifact dictionary 2910. Inputting an artifact ID 2943 (see FIG. 29B) to artifact ID index 2949 yields an artifact-index pointer 2955 that points to the actual artifact data.

In an illustrative embodiment, artifact ID 2943 is the more common of two alternative methods for accessing data artifacts 215. The other method is via subject index 2951. This method involves inputting an encoded subject 2957 to subject index 2951 to obtain a subject-index pointer 2959 that points to the actual artifact data in a manner analogous to artifact-index pointer 2955 discussed above. In one embodiment, encoded subject 2957 is produced by hashing the text value of a search subject. Hash functions suitable for this purpose are well known to those skilled in the computing art.

Artifact Storage table 2953 constitutes a variable-length table that stores actual data-artifact values and other control information. Artifact storage table 2953 maintains a small amount of header control data that appears only once at the beginning of the table.

Artifact type (ART_TYPE) 2961 is a coded representation of the type 210 (e.g., affiliation, clipping, etc) of the associated data artifact 215. In some embodiments, all of the data artifacts of a particular type are placed in a single instance of artifact dictionary 2910. For example, all location data artifacts 215 might be stored in one instance of artifact dictionary 2910, and all affiliation data artifacts 215 might be stored in another instance of artifact dictionary 2910. Such an arrangement can be advantageous for load balancing. Those skilled in the art will recognize that load balancing can be based on a criterion other than data-artifact type 210.

Next-artifact ID (NEXT_ART_ID) 2963 represents the next data-artifact ID to be assigned when a new data artifact 215 is to be added to artifact storage table 2953. This data component is maintained automatically by storage subsystem 1865 as new data artifacts 215 are discovered and added to system 100.

Artifact length (ART_LEN) 2965 stores the length of the selected data artifact 215.

In the rare case of a “collision,” in which two or more different data artifacts 215 of the same type have the same hash code, offset 2967 is used to thread the different instances of those data artifacts 215.

Artifact ID (ART_ID) 2969 replicates the same artifact ID 2943 (see FIG. 29B) used in accessing artifact ID index 2949. This arrangement provides a method for rapidly determining an artifact ID 2969 when presented with an encoded subject 2957. For example, a hash of the subject can be fed to subject index 2951 of artifact dictionary 2910 to obtain an artifact index 2923 that is fed to subject index 2917 of fast index 2905 in obtaining all data artifacts 215 associated with that subject. Also, artifact ID 2969 can be used to assist storage subsystem 1865 when offset 2967 is being used to detect the correct data artifact 215 during collision processing.

Artifact text 2971 is the content (e.g., text) of the data artifact 215 itself. In the case of text, this text string can be of arbitrary non-zero length, as recorded in artifact length 2965.

In some embodiments, ICI subsystem 1800 hierarchically distinguishes data artifacts 215 and portions of multi-word data artifacts 215 by their respective scopes and organizes them accordingly in storage subsystem 1865 to enable search results retrieved from storage subsystem 1865 to be limited in accordance with a scope specified by a user.

For example, there is a natural hierarchy among location data artifacts 215 and portions thereof. The location data artifact “St. Louis, Mo.,” for example, includes a portion of relatively broad geographic scope (“Missouri”) and a portion of relatively narrower geographic scope (“St. Louis”). Distinguishing among these elements hierarchically in storage subsystem 1865 allows search subsystem 125 to limit (triangulate) search results in accordance with a broad scope (“Missouri”) or a narrower scope (“St. Louis”) specified by a user.

This same technique applies to other kinds of data artifacts 215. For example, there is also a natural hierarchy between first names and last names, the latter typically being viewed as the narrower, more specific part of a name, the part used as the index term in directories.

In conclusion, the present invention provides, among other things, a method and system for discovering data artifacts in an on-line data object. Those skilled in the art can readily recognize that numerous variations and substitutions may be made in the invention, its use and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A system for discovering data artifacts in an on-line data object, the system comprising:
a data acquisition subsystem configured to parse the on-line data object into at least one string;
a string pre-parser configured to divide each string into a set of separate characters;
a lexical analyzer configured, for each set of separate characters, to aggregate the separate characters in that set of separate characters into a sequence of tokens, each token in the sequence of tokens being one of a word, a punctuation symbol, a HyperText-Markup-Language tag, and a number;
a syntax analyzer configured, for each sequence of tokens during a first analysis phase, to:
determine, for each of a plurality of rule sets, whether the sequence of tokens includes one or more candidate data artifacts of a distinct type to which that rule set corresponds, each of the plurality of rule sets being adapted to discovery of the distinct type of data artifact to which that rule set corresponds, at least one rule set in the plurality of rule sets including a context-free grammar;
compute, for each candidate data artifact of a distinct type, a probability ranking indicating a degree of likelihood that the candidate data artifact is a data artifact of that distinct type; and
classify each candidate data artifact as a data artifact of the distinct type for which a most favorable probability ranking was computed for that candidate data artifact;
the syntax analyzer being configured to associate with each classified data artifact a subject found within the on-line data object; and
a storage subsystem including at least one data structure in which to store the classified data artifacts, the storage subsystem being configured to index and organize the classified data artifacts by subject for retrieval in response to a search query indicating a particular subject.

2. The system of claim 1, wherein the on-line data object is a Web page.

3. The system of claim 2, wherein the system is configured to process a collection of Web pages encompassing substantially all of the World Wide Web.

4. The system of claim 2, wherein the data acquisition subsystem is configured to remove duplicate Web pages from the collection of Web pages.

5. The system of claim 1, wherein the on-line data object is one of a Usenet news posting, an e-mail message, and a Web feed

6. The system of claim 1, wherein a subject is a name of a person.

7. The system of claim 1, wherein the syntax analyzer is configured, for a given distinct type of data artifact, to:
match one or more tokens in the sequence of tokens with at least one of a set of predetermined patterns defined by the context-free grammar of the rule set that corresponds to the given distinct type of data artifact, wherein, in matching one or more tokens in the sequence of tokens with at least one of a set of predetermined patterns defined by the context-free grammar of the rule set that corresponds to the given distinct type of data artifact, the syntax analyzer is configured to compare at least one token among the one or more tokens with a database of known data values.

8. The system of claim 7, wherein the given distinct type of data artifact is a name of a person and the database of known values is a database of known name parts, the database of known name parts including at least one of first names, last names, name prefixes, and name suffixes.

9. The system of claim 8, wherein the syntax analyzer is configured to:
identify at least one morphological variation of a candidate name-part token before the candidate name-part token is compared with a database of known name parts including first names; and
compare each of the at least one morphological variations with the database of known name parts including first names.

10. The system of claim 8, wherein the syntax analyzer is configured to recognize a group of tokens as a candidate name of a person when the group of tokens includes a combination of a candidate name-part token that is found in the database of known name parts and a candidate name-part token that is not found in the database of known name parts.

11. The system of claim 7, wherein the given distinct type of data artifact is a geographic location and the database of known values is a database of known geographic locations, the database of known geographic locations including at least one of countries, U.S. states, partial names of U.S. states, provinces, cities, partial names of cities, and place names.

12. The system of claim 11, wherein data artifacts classified as a geographic location are hierarchically distinguished by their respective geographic scopes in the storage subsystem to enable search results retrieved from the storage subsystem to be limited in accordance with a geographic scope specified by a user.

13. The system of claim 7, wherein the given distinct type of data artifact is a name of an organization and the database of known values is a database of known organization names, the database of known organization names including at least one of organization root names and organization suffixes.

14. The system of claim 13, wherein the syntax analyzer is configured to infer an affiliation between a name of a person and a data artifact classified as a name of an organization based at least in part on proximity, within the on-line data object, of the data artifact classified as a name of an organization to the name of the person.

15. The system of claim 1, wherein the syntax analyzer is configured, for each sequence of tokens during a second analysis phase subsequent to the first analysis phase, to:
apply to the sequence of tokens a tags rule set distinct from the plurality of rule sets, the tags rule set corresponding to a tag data-artifact type, the tags rule set being adapted to discovery of the tag data-artifact type, the tags rule set including a context-free grammar;
match one or more tokens in the sequence of tokens with at least one of a set of characteristic tag patterns defined by the context-free grammar, the one or more tokens not having been classified as a data artifact during the first analysis phase, wherein, in matching one or more tokens in the sequence of tokens with at least one of a set of characteristic tag patterns defined by the context-free grammar, the syntax analyzer is configured to compare a token among the one or more tokens with a database of tag terms, the database of tag terms including at least one of nouns, pronouns, prepositions, conjunctions, articles, and auxiliary verbs; and
when the tags rule set is satisfied:
classify the one or more tokens as a tag data artifact; and
associate the tag data artifact with a subject found within the on-line data object.

16. The system of claim 15, wherein the syntax analyzer is configured, when the tags rule set is satisfied, to determine a key-token density of the one or more tokens and to classify the one or more tokens as a tag data artifact when the key-token density satisfies a predetermined key-token-density criterion.

17. The system of claim 15, wherein the tag data artifact represents miscellaneous information about the subject associated with the tag data artifact.

18. The system of claim 1, wherein the syntax analyzer is configured, for each sequence of tokens during an analysis phase subsequent to the first analysis phase, to:
apply to the sequence of tokens a text-block rule set distinct from the plurality of rule sets, the text-block rule set corresponding to a text-block data-artifact type, the text-block rule set being adapted to discovery of the text-block data-artifact type, the text-block rule set including a context-free grammar;
match at least a portion of the sequence of tokens with at least one of a set of characteristic text-block patterns defined by the context-free grammar; and
when the text-block rule set is satisfied:
classify as a text-block data artifact the at least a portion of the sequence of tokens; and
associate the text-block data artifact with a subject found within the on-line data object.

19. The system of claim 18, wherein the text-block data-artifact type is one of a clipping, an item concerning education, and a biography.

20. The system of claim 18, wherein the text-block data artifact contains within it at least one previously discovered data artifact.

21. The system of claim 1, wherein the distinct types of data artifacts include at least one of an identifier associated with a manner of electronically communicating with a person, a hobby, an interest, and an image, each image data artifact having a corresponding image reference, the image reference corresponding to each image data artifact being stored in the storage subsystem.

22. The system of claim 1, wherein the string pre-parser is configured to convert each set of separate characters to a canonical form in a predetermined target language.

23. The system of claim 1, wherein the storage subsystem includes a fast index and an artifact dictionary, the classified data artifacts being stored non-redundantly in the artifact dictionary, the fast index containing pointers to the artifact dictionary, the pointers being organized by subject.

24. The system of claim 23, wherein at least one of the fast index and the artifact dictionary is distributed over a plurality of servers.

25. The system of claim 1, wherein data artifacts of a given distinct type and portions thereof are hierarchically distinguished by their respective scopes in the storage subsystem to enable search results retrieved from the storage subsystem to be limited in accordance with a scope specified by a user.
